(19) United States
(12) Patent Application Publication
(10) Pub. No.: US 2011/0166030 A1
(43) Pub. Date: Jul. 7, 2011

(54) Prediction of response to docetaxel therapy based on the presence of TMPRSSG2:ERG fusion in circulating tumor cells

(76) Inventors: Yixin Wang, Basking Ridge, NJ (US); Yuqiu Jiang, San Diego, CA (US); John F. Palma, Carlsbad, CA (US)

(21) Appl. No.: 12/924,506

(22) Filed: Sep. 28, 2010

Related U.S. Application Data
(60) Provisional application No. 61/247,161, filed on Sep. 30, 2009.
(60) Provisional application No. 61/247,178, filed on Sep. 30, 2009.

(51) Int. Cl. C40B 30/00

(52) U.S. Cl. 506/7

(57) ABSTRACT

A method for predicting with high specificity from RTPCR detected markers if a patent is likely to respond to docetaxel treatment is disclosed. RTPCR detects the presence of absence of certain mutations due to fusion events. Together, with other protein markers, additional stratification is possible to identify patents suited for docetaxel therapy as opposed to for alternative treatments.

### REFERENCE TO RELATED APPLICATIONS

This application claims priority to and the benefit of the provisional patent applications 61/247,161 and 61/247,178, both filed on Sep. 30, 2009. The entire disclosure of these provisional patent applications is incorporated by reference herein.

### INTRODUCTION

Prostate cancer, typically encountered as a carcinoma—i.e., of epithelial origin, is one of the leading causes of mortality from cancer among males in the United States. Prostate cancer typically is of luminal origin and it has been proposed that it originates from luminal epithelial stem cells. Further, many genomic rearrangements, such as TMPRSS2 ERG fusion events, are observed in prostate cancer, possibly indicating subtypes of prostate cancer, many of which may be detected using techniques such as FISH. The utilization of such markers, and additional markers like serum proteins and cell types to estimate the progression of prostate cancer and modulate its treatment has been, at best, a difficult goal.

Prostate cancer or benign prostate hyperplasia affects a majority of men during their lifetime. Many instances of the relatively slow growing prostate cancer pose little threat because other causes of mortality precede it. Metastatic prostate cancer, however, is aggressive, lethal and difficult to track and manage. Presently, treatment possibilities are primarily palliative with better treatment modalities expected from persistent efforts.

Typically cancers are graded to determine the appropriate treatment, which is often based on how advanced and aggressive the cancer happens to be. The grading may be according to tumor size, or the extent of metastasis and on the difference between the appearance of the tumor cells and normal tissue. Unlike many tumors, prostate cancer presents difficulties in grading and tracking its progression because it tends to spread to bone, where it is not readily accessible for imaging or even invasive examination. Markers suitable for tracking its progression have been bogged down by the considerable variability, for instance due to extensive mutations, translocations and other events in the cancerous cells.

Nevertheless, prostate cancer is often detected and the effectiveness of treating it tracked using markers, prominent among which is Prostate Specific Antigen (“PSA”). PSA levels can be readily detected in a blood test. Typically PSA levels are measured at two or more time points and compared to determine if the levels are elevated, stable or decreasing. PSA levels may be elevated not only due to the presence or growth of prostate cancer, but also due to benign prostate hyperplasia and may, inexplicably, be low in the presence of some aggressive cancers. This, of course, makes absolute reliance on PSA questionable. However, in the absence of better markers, PSA levels may have to be used to track the efficacy of a particular treatment.

Treatment for prostate cancer spans a broad range of options. Prostate cancer typically is responsive to testosterone, which property is used to thwart its growth by using inhibitors or by otherwise reducing the available testosterone. For slow growing prostate cancer in older males, often no therapy is recommended because other causes of mortality are far more likely to dominate anyway and the side-effects of therapy adversely impact the quality of life while providing questionable benefits. On the other hand, some prostate cancers are very aggressive and almost inevitably lethal, and, thus do require intervention. When required, treatment may include local radiation, and/or complete or partial removal of the prostate and/or even orchieoctomy (castration to reduce testosterone levels.) Often, after remission the cancer returns in a form non-responsive to withdrawal of testosterone, i.e., Androgen Independent Prostate Cancer (“AIPC”), which almost always is terminal.

Not all prostate cancers are suitable for surgical intervention. Aggressive prostate cancers that are resistant to surgical intervention are treated with chemotherapy. Such chemotherapeutic agents include Adriamycin, Docetaxel, Estramustine, Mitoxantrone, Paclitaxel, other taxanes, Prednisone, and immunotherapy targeting various antigens, such as using Sipuleucel, vaccines and nilutamide, the like administered alone or in a combination. Martel et al., “Current Strategies in the Management of Hormone Refractory Prostate Cancer” in Cancer Treatment Reviews 29:171-187 (2003) provide a discussion of the varied approaches tried to treat AIPC. The success of these approaches in non-stratified patients with AIPC is mixed at best with the exception of Docetaxel in combination with prednisone. Presently, the first line treatment for AIPC is administration every three weeks of Docetaxel with prednisone, which combination replaced Mitoxantrone with prednisone in view of improved overall survival observed in clinical trials. Mitoxantrone with prednisone provided a better quality of life due to less severe side-effects, but also did not improve OS.

Docetaxel with prednisone, the first line treatment of choice for such patients, causes severe side-effects. The overall survival of patients treated with Docetaxel ranges from as short as a couple of months to many years. The median survival is, however, increased in comparison with other treatment regimes. Thus, the increased overall survival with this therapy is often at the cost of a greatly diminished quality of life. This presents a dilemma with no ready solution to patients suffering from prostate cancer. Overall, for prostate cancer patients with distant metastasis, almost all succumb to the disease and no therapy significantly prolongs survival although some candidate therapies continue to be developed although there is significant variation from patient to patient.

Indeed, it has been proposed that in view of the difficulties in tracking prostate cancer and its response to treatment, the outcome measures in clinical trials should focus on whether a treatment has failed instead of trying to detect if it has been successful. A preferred endpoint for a treatment is Progression-Free Survival (“PFS”), which is the time from the start of therapy to a time point selected from death, evidence of progression of disease, and the last follow-up. An alternative measure is Overall Survival (“OS”), which only measures survival regardless of the cause of death or the time to the last testing of/contact with the patients following initiation of therapy.

In addition to determining effective treatments, the challenge of detecting and tracking prostate cancer and the efficacy of treatment is yet another difficult problem. One technique that has provided better estimates of OS than PSA increases is the detection of Circulating Tumor Cells (“CTC”). However, this far more complex technique does not help stratify patients or improve treatment options with sufficient granularity. Other techniques have focused on features like tissue remodeling and angiogenesis associated with prostate cancer. Vascular remodeling involves endothelial cells. Circulating endothelial cells (“CEC”) have also been detected, but their utility has not been clear cut. CEC utility in patient stratification has also been far from clear and it should be noted that it is not unlikely that elevated CEC and CTC are indicators of similar results due to cancer related processes although CEC may also reflect other sources of tissue injury and/or modification.

### SUMMARY

Inventors note that no single treatment seems to be indicated for all patients with metastatic prostate cancer while significant side-effects accompany most treatments. Thus, there is an unmet need to stratify patients to better treat metastatic prostate cancer to avoid delays that may lead to painful or even fatal consequences while providing the best quality of life to patients—a balancing act made increasingly difficult by the heterogeneous nature of prostate cancer. Disclosed is the utilization of including genomic fusion events, serum proteins and cell types to modulate prostate cancer treatment.

It is further proposed herein that with effective stratification based on prognostic indicators of outcome alternative treatments may be directed to those least likely to benefit from relatively conventional treatments. Further, there are many other promising treatments under development, including some that may even eliminate prostate cancer, such as monoclonal anti-bodies against the CTLA-4 antigen, which are slowed down by the difficulty in recruiting sufficient number of patients. To assist in the rapid development of more effective treatments and for most effective administration of current treatments, it is proposed herein that patients least likely to respond to docetaxel, the first line of treatment be identified so that the very limited treatments options for such patients can be expanded to include such new promising treatments and a better quality of life. Upon establishment, other treatments may supplant docetaxel as the first line of treatment with the method applied to stratify patients to develop yet better treatments applicable, alone or in combination, to improve the outcome for all patients afflicted with prostate cancer.

Methods and markers are disclosed herein to stratify patients with very high specificity. Preferably, a first strata of patients is identified with a specificity of about 85%, more preferably greater than 90% and most preferably greater than 95% for being responsive to a first treatment. In a preferred embodiment, patients not belonging to the first strata are further stratified to identify those most likely to respond to the first treatment in a second strata. Patients not belonging to the first or second strata are considered for a second treatment. In a preferred embodiment the first treatment comprises docetaxel. In a preferred embodiment, the second treatment is selected from the group consisting of Adriamycin, Estramustine, Mitoxantrone, Paclitaxel, administration of an antibody against CTLA4, an antibody directed to PSA, and Prednisone.

Inventors noted that to the extent disease progression is not observed in a group of patients, a lower limit is placed on OS and, in a preferred embodiment, a method is disclosed to consistently stratify patients based on either PFS or OS based data even if the end point used to determine PFS is, in general, not prognostic for OS.

Methods and markers are disclosed herein to follow the progression of prostate cancer with an area under the curve measure greater than that possible with PSA. In a preferred embodiment, the area under the curve measure is greater than that possible with the detection of Circulating Tumor Cells (“CTC”), which are believed, without being bound by theory, as being a better indicator of prostate cancer than PSA alone. More preferably, the markers comprise one or more of the group consisting of an increase in Circulating Endothelial Cells (“CEC”) following initiation of treatment, and a decrease in Tissue Factor (“TF”) following initiation of treatment. Preferably CEC and TF measurements are made within six (6) weeks of initiation of treatment, more preferably CEC and TF measurements are made within five (5) weeks of initiation of treatment and most preferably CEC and TF measurements are made within two to five (2-5) weeks of initiation of treatment. In a preferred embodiment, the increase in CEC indicates an increase of at least 3.8 cells in 4 mL. In a preferred embodiment, the decrease in TF indicates any decrease in measure TF levels beyond experimental errors within the first five weeks following treatment.

In a preferred embodiment, a first strata is identified by detecting the presence of a TMPRSS2:ERG fusion event in CTCs. More preferably, the fusion event is a TMPRSS2:ERG (T1-E4) fusion event or a TMPRSS2:ERG (T2-E4) fusion event, wherein the T1, T2, and E4 denote the relevant exon segments of the coding regions of interest.

Further objects, features, and advantages of the present application will be apparent to those skilled in the art from detailed consideration of the preferred embodiments, experiments and their associated figures that follow.

### DESCRIPTION OF FIGURES

The patent or application file contains at least one drawing executed in color. Copies of this patent or patent application publication with color drawing(s) will be provided by the Office upon request and payment of the necessary fee.

FIG. 1. The expression pattern of these 11 prostate cancer genes in 40 androgen-independent prostate cancer patients and 50 normal donors. a) The number of CTCs was represented in true number divided by 100. The Y axis represents the expression level of candidate genes in the form of 40 minus Ct number detected by real time quantitative RT-PCR. Larger number means higher expression. The blue bar represents the mean value of either CTC number or expression level of typical gene in AIPC patient and normal donor population. Expression of candidate gene PSA, AR, AGR2, SPDEF, T1E4, and T2E4 was represented in this graph. b) Expression of candidate gene PSMA, EGFR, HER2, PSCA, and Ck19 was shown in this FIG. 1(a) below.

FIG. 2. PCA analysis with PSA, AR, AGR2, SPDEF, T1E4, and T2E4 expression data in AIPC patients. The 5 patients represented by triangles well above the distribution of other patients and separated from the rest of AIPC population formed a unique subgroup.

FIGS. 3(a) and 3(b). Unsupervised clustering of AIPC patients using PSA, AR, AGR2, SPDEF, T1E4, and T2E4 expression data. The X axis represents individual patient clustered in various subgroups and the Y axis listed the candidate gene name. Black color indicates higher expression and light gray color represents relatively lower expression in FIG. 3(a) while blue color indicates higher expression and red color represents relatively lower expression in FIG. 3(b).

FIG. 4 illustrates the observed generalized course of tumor and vascular markers during treatment. Panels A-D: CEC numbers increased significantly within 2-5 weeks of treatment, whereas CTC numbers decreased. Both remained stable thereafter. No treatment effects on ET-1 levels were observed. Serum TF declined after 6-8 weeks of treatment. Panels E-H: To assure that the observed alterations in biomarkers was not the result of inter individual differences; repeated linear regression analyses were performed. This confirmed the reported alterations in biomarker levels. NS=not significant.

FIG. 5 shows observed associations of baseline levels and changes in CEC, ET-1, and TF levels with OS, and CTC numbers at baseline and 2-5 weeks. Panels A-D: No prognostic value for OS could be determined for baseline values of the tested markers but CTC numbers. Panel E-H: At 2-5 weeks, patients with a ≧3.8 fold increase in CEC counts, with CTC counts ≧5 cells/7.5 mL or with a decrease in TF levels were characterized by a markedly worse OS. Please note that the blue line in panel H denotes a decrease in TF instead of an increase—as is indicated in the key due to a typographical error. HR=hazard ratio, HR=hazard ratio determined in univariate Cox proportional-hazards regression. CI=confidence interval.

FIG. 6 illustrates risk factors and overall survival. Association of the number of risk factors present at 2-5 weeks (>3.8 fold increase in CEC, a decrease of TF, and a CTC number of ≧5 cells/7.5 mL) with OS. HR=hazard ratio determined in univariate Cox proportional-hazards regression. CI=confidence interval.

FIG. 7A illustrates parameters associated with PSA declines of greater than or less than 30%, specifically:
Logrank: P=0.25;
Cox HR: P=0.26, HR=0.79 [0.5-1.2];
Median OS: Decrease =>30%=16.9 months; and
   Decrease <30%=13.3 months.

FIG. 7B illustrates parameters associated with PSA declines of greater than or less than 50%, specifically:
Logrank: P=0.34;
Cox HR: P=0.56, HR=0.87 [0.5-1.4];
Median OS: Decrease =>50%=13.6.9 months; and
   Decrease <50%=14.5 months.

FIG. 8A illustrates parameters associated with combination of CTC counts <5/7.5 mL with additional identified markers, specifically:
Logrank: P=0.017;
Cox HR: P=0.019, HR=1.5 [1.1-2.2];
Median OS: No risk factors=24.2 months;
   CEC risk=15.7 months;
   TF risk=16.0 months; and
   CEC and TF risks=10.0 months.

FIG. 8B illustrates parameters associated with combination of CTC counts <5/7.5 mL with additional identified markers, specifically:
Logrank: P=0.022;
Cox HR: P=0.014, HR=2.1 [1.2-3.8];
Median OS: No risk factors=24.2 months;
   1 risk factor=16.0 months; and
   2 risk factors=10.0 months.

FIG. 8C illustrates parameters associated with combination of CTC counts >=5/7.5 mL with additional identified markers, specifically:
Logrank: P=0.003;
Cox HR: P=0.005, HR=2.1 [1.2-3.4];
Median OS: No risk factors=15.4 months;
   CEC risk=insufficient data, only 1 subject;
   TF risk=13.1 months; and
   CEC and TF risks=6.1 months.

FIG. 8D illustrates parameters associated with combination of CTC counts >=5/7.5 mL with additional identified markers, specifically:
Logrank: P=0.002;
Cox HR: P=0.003, HR=3.3 [1.5-7.1];
Median OS: No risk factors=15.1 months;
   1 risk factor=11.4 months; and
   2 risk factors=6.1 months.

### DETAILED DESCRIPTION OF PREFERRED EMBODIMENTS

The relationship between PFS and OS is difficult to evaluate. Patients in clinical trials are typically selected in view of evidence of progression of disease, for instance as indicated by radiographic scans or consecutive increases in PSA levels. A decline in PSA levels following therapy is relevant to PFS estimates, but does not necessarily indicate increased OS. For many patients with early evidence of progression (radiographic or based on PSA increases) death resulted fairly late while patients with late evidence of disease progression, although few in number seem to progress to death relatively rapidly. In other words, there is considerable heterogeneity in patients exhibiting early signs of disease progression or that PFS and OS are not perfectly correlated.

Such data have been interpreted to stand for the notion that using markers in general to track prostate cancer soon after treatment is not practical and that no method was likely to be effective in tracking the progression of prostate cancer within six or so weeks following initiation of a treatment. The heterogeneity presented by prostate cancer was largely overlooked in arriving at the inference that disease progression detection close to initiation of treatment is suspect and should not be used to change treatment course.

This disclosure demonstrates a measure of progression of prostate cancer that is effective even immediately following initiation of treatment. Thus, it is more likely that the difficulties encountered by other investigators reflect the drawbacks with the particular measures of cancer progression used by them. Further, it is, then, reasonable to treat prostate cancer as a collection of different types of cancers that are somewhat similar in many respects thus somewhat accounting for the observed heterogeneity in responses and treatments in view of this disclosure. Thus, PSA levels may be useful in tracking some sub-types of prostate cancer as opposed to prostate cancer in general. The post-treatment measures of cancer progression disclosed herein are superior because they are effective even immediately following initiation of treatment, in particular within the first six weeks following the initiation of treatment, which was not possible with the other known markers of prostate cancer in general or they predict with high accuracy the response to a particular treatment.

Stratifying patients based on response to treatment can segregate sub-types of prostate cancer that are best treated in a similar manner while providing the best overall quality of life. Stratification, preferably, is carried out using markers either before initiation of treatment or during early treatment. The disclosed markers are nucleic acid based or protein based or even in the form of cell types.

In a preferred embodiment, a first strata is identified by detecting the presence of a TMPRSS2:ERG fusion event in CTCs. More preferably, the fusion event is a TMPRSS2:ERG (T1-E4) fusion event or a TMPRSS2:ERG (T2-E4) fusion event, wherein the T1, T2, and E4 denote the relevant exon segments of the coding regions of interest. RTPCR based detection in circulating tumor cells of the expression of one of the TMPRSS2-ERG gene fusions in circulating CTCs defines a first strata.

Described below are several embodiments or parts thereof in view of various data for different types of markers and indicators investigated herein.

### 1. Example 1

### RTPCR Based Detection of Markers for Stratification with High Specificity

Thus, disclosed herein is a method of expression profiling of gene of interest in CTCs using real time quantitative RT-PCR. Briefly, in a proof of concept, in total RNA isolated from circulating tumor cells of each of 40 metastatic prostate cancer patients gene expression profiles of 14 candidate genes were investigated by real time quantitative RT-PCR. By this approach it is possible to demonstrate that the TMPRSS2-ERG fusion gene expression is useful for predicting response to Docetaxel treatment in AIPC patients. Based on this application of RT-PCR based detection of the TMPRSS2-ERG fusion gene expression, patients are stratified for effective treatment with docetaxel chemotherapy, with an overall improvement in disease outcome and quality of life with very high specificity. In the sample described herein, all of the patients testing positive for at least one of the two detected TMPRSS2-ERG gene fusion events also exhibited a response to docetaxel therapy as measured by a reduction in PSA levels following initiation of docetaxel therapy. These results further demonstrate that gene expression profiling of CTCs is viable and useful for helping physicians treat androgen-independent prostate cancer patients in a personalized way and deliver superior patient care.

a. Study Patients

Briefly, the 40 subjects were recruited from the Cedars-Sinai Medical Center in Los Angeles. Appropriate IRB approvals were obtained prior to patient sample collection. The inclusion criteria consisted of: patient must be at least 18 years old and with clinical diagnosis of Stage IV (metastatic) prostate cancer; patients must provide written consent/authorization to participate in this study, no signs or symptoms of active infection, willing and able to comply with procedures required in this protocol.

b. Isolation and Enumeration of CTC

CTCs were isolated and enumerated using the CELLSEARCH™ System (VERIDEX™ LLC, Raritan, N.J.). Blood samples of the patients were drawn into 10 mL CELLSAVE™ tubes (VERIDEX™ LLC, Raritan, N.J.), which contained a cellular preservative agent. The samples were maintained at room temperature and processed within 72 hours after collection. All CTC evaluations were done at VERIDEX™'s La Jolla facility. The CELLSEARCH™ System consists of an automated sample preparation system. The CELLSEARCH™ Epithelial Cell kit was used to immunomagnetically enrich cells expressing the epithelial cell adhesion molecule. The isolated cells were then fluorescently labeled with the nucleic acid dye 4′,6-diamidino-2-phenylindole and labeled monoclonal antibodies specific for leukocytes (CD45-allophycocyanin) and epithelial cells (cytokeratin 8,18,19-phycoerythrin). Identification and enumeration of CTCs was done using the CELLSPOTTER™ Analyzer (VERIDEX™ LLC, Raritan, N.J.), a semiautomated fluorescence microscopy system that permits computer-generated reconstruction of cellular images. CTCs were defined as nucleated cells lacking CD45 and expressing cytokeratin.

c. Nucleic Acid Isolation from CTC

Blood samples were collected in 10 ml EDTA VACUTAINER™ tube (BECTON DICKINSON™, Franklin Lakes, N.J.) and processed within 36 hours collection using the CELLSEARCH™ system with the CELLSEARCH™ Profile kit (VERIDEX™ LLC, Raritan, N.J.). The isolated CTCs were dispensed into the original AutoPrep tube (VERIDEX™ LLC, Raritan, N.J.). Then, the AutoPrep tube with the sample from Celltracks AutoPrep System was removed and placed into MagCellect Magnet for a 10-minute incubation. A brownish line appeared during incubation. This line was the ferrofluid containing the bound cells. With conical tube still in MagCellect Magnet liquid was aspirated off with Pasteur pipette carefully, not to disrupt the ferrofluid bound cells. The tube was removed from the magnet. Using 1 ml pipetmen, 350 μL of Qiagen AllPrep DNA/RNA Micro Kit Lysis Buffer (RLT Plus) was added to the ferrofluid bound cells and the mixture was vortexed for 30 seconds to lyse the cells. If clumping of ferrofluid was evident after 30-second vortex, continue to vortex in 10 second intervals until ferrofluid was in solution. The sample was centrifuged at 800×g for 10 seconds to pellet ferrofluid and insoluble debris. The supernatant was used for RNA isolation using Qiagen RNAeasy micro kit according to manufactory's protocol.

d. cDNA Synthesis, Pre-Amplification, and RTQ-PCR Analysis

First strand cDNA was synthesized using 10 ng total RNA and High Capacity cDNA Archive kit from Applied Biosystems (ABI). The cDNA was amplified with the ABI TaqMan™ PreAmp method and reagents that are suitable for multiplexing up to 100 gene expression targets. The selected candidate genes and the housekeeping control genes were evaluated using RTQ-PCR assay with the pre-amplified material. To prevent any contaminating DNA in the samples from amplification, PCR primers or probes for RTQ-PCR assay were designed to span an intron so that the assay would not amplify any residual genomic DNA. PCR amplification was performed on the ABI 7900HT sequence detection system (Applied Biosystems, Foster City, Calif.) using the 384-well block format with 10 μL reaction volume. The concentrations of the primers and the probes were 4 and 2.5 μmol/L, respectively. The reaction mixture was first incubated at 950 C for 10 minutes to activate AmpliTaq™ then 40 cycles of 950 C for 15 seconds for denaturing and of 600 C for 1 minute for annealing and extension. In addition, all primers and probes were optimized towards the same amplification efficiency according to the manufacturer's protocol. Sequences for the primers and probes for the 12 genes and 2 housekeeping control genes are listed in Table 1 and each is written in the 5′ to 3′ direction. β-Actin, TACSTD1, AR, BST1, EGFR, HER2, and PSMA probes have 5′ FAM label and 3′ MGB label, while the rest of genes have 5′ FAM label and 3′ BHQ label.

TABLE 1
Primer and probe sequences of the candidate genes

| Gene | | | |
|---|---|---|---|
| Symbol | Forward | Reverse | Probe |
| ACTB | CAGCCTTCCTTCCTGGGC | ACACTTCATGATGGAGTTGA | TCCTGTGGCATCCAC |
| | | AGGTAG | |
| TACSTD1 | AGTTTGCGGACTGCACTTCA | AATACTCGTGATAAATTTTG | AAGGAGATCACAACGC |
| | | GATCCA | GT |
| BST1 | CCCGAGCAGCGGAACA | TCCTTGTCCAGCGCCACT | CCATCTGGGAAGCCT |
| CK19 | AGATGAGCAGGTCCGAGGT | CCTGATTCTGCCGCTCACT | ACAGCTGAGCATGAAA |
| | TA | ATCA | GCTGCCTT |
| PSA | TGCGGCGGTGTTCTGGTGC | GACCTGAAATACCTGGCCT | CAGGAACAAAAGCGTG |
| | A | GTGTC | ATCTTGCTGG |
| AR | CGAATGAGGCACCTCTCTC | TCAGCCCATCCACTGGAAT | CCAGGAATTCCTGTGC |
| | AA | AAT | ATG |
| AGR2 | CAGATACAGCTCTGTTGCTT | GACAGACAGAAGGGCTTGG | AGAAAGCTCTCAAGTTG |
| | GACA | AGA | CTGAAGACTGAATTGTA |
| | | | AAG |
| TMPRSS2- | TGGAGCGCGGCAGG | TGGCGTTCCGTAGGCAC | CCTTATCAGTTGTGAGT |
| ERG (T1- | | | GAGGACCAGTCGTTG |
| E4) | | | |
| TMPRSS2- | CATTCCAGATACCTATCATT | GACTGGTCCTCACTCACAA | TGTTGATAACAGCAAGA |
| ERG (T2- | ACTCGATG | CTGA | TGGCTTTGAACTCAGA |
| E4) | | | |
| EGFR | GAGGAATTATGATCTTTCCT | CCACTGTGTTGAGGGCAAT | CAGGAGGTGGCTGGT |
| | TCTTAAAGAC | G | |
| HER2 | AACCTGACCTCTCCTACATG | CCAGGTCCACACAGGAGTG | TGGAAGTTTCCAGATGA |
| | CC | G | GGAG |
| PSCA | CTGTTGATGGCAGGCTTGG | TTGCTCACCTGGGCTTTGC | GCAGCCAGGCACTGCC |
| | C | A | CTGCT |
| SPDEF | CGCCCACCTGGACATCTGG | CACTGGTCGAGGCACAGTA | GTCAGCGGCCTGGATG |
| | A | GTGA | AAAGAGCGG |
| PSMA | CCAGAGGGCGATCTAGTGT | CATGTCCCGTTCCAATTTAA | CTATGCACGAACTGAA |
| | ATGTT | AGA | G |

e. Data Analysis

Principle component analysis (PCA) was conducted to examine the separation of samples based on the PCR results of the genes using Partek Genomic Suite-4 (Partek Inc., St. Louis, Mo.). Pearson correlation matrix was used in the analysis. Unsupervised hierarchical clustering was performed using Partek Genomic Suite-4 after the PCR data was normalized through linear scaling per gene (the minimum was set at 0 and the maximum was set at 1). Both samples and genes were clustered based on Euclidean distance with the average linkage method.

f. Results

### i. Patient Characteristics

Clinical and pathological features are summarized in Table 2. All patients were receiving treatments at Cedars-Sinai Medical Center at Los Angeles and all have metastatic prostate cancers. The information included patient serum PSA level, PSA doubling time (PSADT) that is roughest estimate from immediate two prior values, with or without bone metastatic disease and the scope of the disease (extensive or focal), measurable metastatic diseases on other organs (yes or no), types of therapies (salvage or initial), and status of response to the therapy. 15 patients were treated with salvage therapy, 14 patients were treated with Docetaxel as the initial therapy after being diagnosed with metastatic diseases, and 11 patients were treated with Docetaxel plus RAD001 that is a rapamycin inhibitor developed by Novartis. 24 of the 40 patients had extensive bone metastatic disease and 12 patients had measurable disease in soft tissues. Fifty healthy donor blood samples were also collected from Scripps Clinic in San Diego as the control population. In some of the analysis, patients on salvage therapy were excluded because they did not provide information on treatment with docetaxel in the first instance, but rather, possible renewed sensitivity to docetaxel following other interventions.

TABLE 2
Patient characteristics

| Characteristics | Number of Patients | |
|---|---|---|
| Age | 69 | |
| Therapy | | |
| Salvage | 15 | |
| Tax | 14 | |
| Tax + RAD | 11 | |
| Sites of metastasis | | |
| Bone only (extensive) | 24 | |
| Bone only (focal) | 4 | |
| Bone and soft tissue | 10 | |
| Soft tissue only | 2 | |
| Response to treatment | | |
| Salvage | 1 | |
| Tax | 7 | |
| Tax + RAD | 6 | |
| No response | 13 | |
| Undefined | 13 | |
| CTC count per 7.5 ml blood, median | 19 | (0-2362) |
| Prostate-specific antigen (ng/ml), median | 150 | (0.1-2402.7) |

g. CTC Enumeration

7.5 mL of patient blood samples were collected into CellSave tube and the number of CTCs present in the blood sample was identified and counted with CellSearch system. As shown in Table 3, 35 of the 40 metastatic prostate cancer patients had CTC present in 7.5 mL collected blood. Thirty patients (75%) had five or more CTCs. Patient 13RM had more than 2300 CTCs. No CTCs were detected in the normal donor population.

TABLE 3
Number of CTCs for each patient

| Patient ID | Number of CTCs |
|---|---|
| 1-HR | 37 |
| RSM-3 | 22 |
| 4-GLB | 7 |
| 5-AIE | 1033 |
| 6-HCE | 323 |
| 7-JS | 28 |
| 8-LK | 1 |
| 9-TP | 17 |
| 10-GF | 12 |
| 011B-K | 10 |
| 12BP | 690 |
| 13RM | 2362 |
| 14MRK | 2 |
| 015JB | 0 |
| 016WJ | 0 |
| 017-AB | 2 |
| 018LAJ | 0 |
| 019WC | 4 |
| 20FS | 12 |
| 021JS | 37 |
| 22FG | 7 |
| 23RS | 76 |
| 24WS | 36 |
| 25DN | 7 |
| 26CG | 9 |
| 27AK | 0 |
| 28 RP | 594 |
| 29 CR | 849 |
| 31DJ | 0 |
| 32SP | 88 |
| 33HP | 5 |
| 34LS | 1378 |
| 35 RM | 108 |
| 36 SP | 27 |
| 37TP | 59 |
| 38 PB | 189 |
| 39 LS | 282 |
| 40 BP | 2 |
| 41 RM | 19 |
| 42 LG | 66 |

h. Candidate Gene Expression Analyses of Isolated CTCs

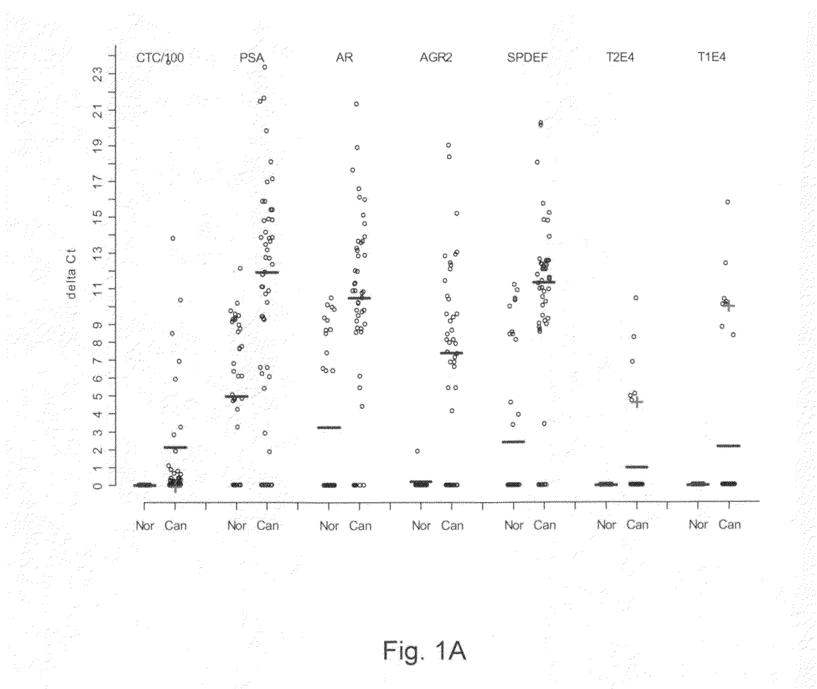

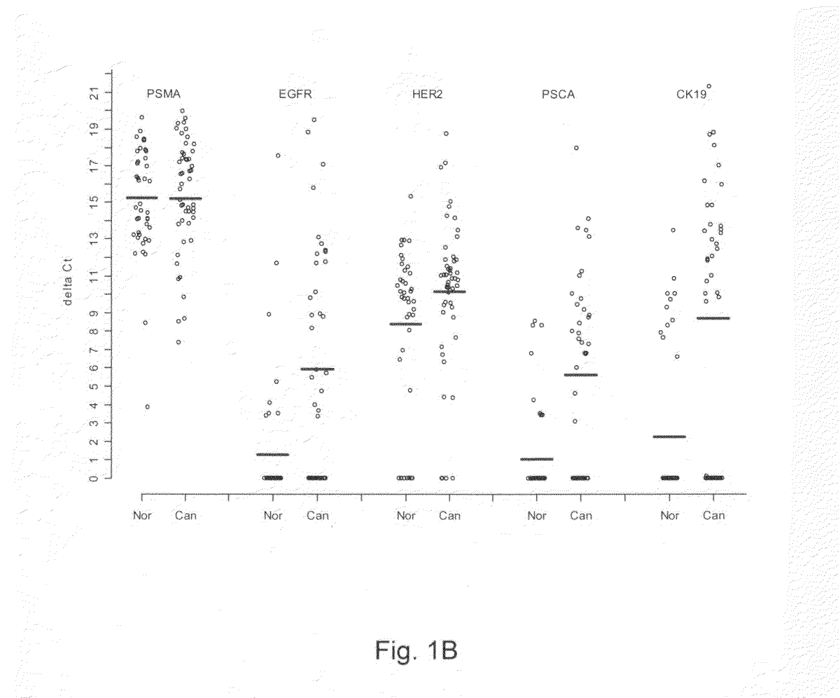

14 molecular markers that include 12 prostate and/or epithelial cell specific genes and 2 control genes were optimized to achieve the best sensitivity and specificity by testing the primers and probes in normal donor's blood samples and cells of LnCAP cell line (data not shown). The quantitative RT-PCR of these 14 genes was performed using the ABI Pre-Amp method and total RNA samples isolated from the purified CTC population and normal donors. The results were shown in FIGS. 1a and 1b. The expression of PSA, AR, AGR2, and SPDEF genes were up-regulated in the metastatic prostate cancer patients and showed no significant expression in the majority of normal donors. The TMPRSS2 and ERG fusion gene expression was detected explicitly in the cancer patient population. 8 (20%) patients had the T1E4, which the exon 1 of TMPRSS2 gene fused with exon 4 of the ERG gene. 6 patients of these 8 T1E4 patients were also T2E4 positive (exon 2 of TMPRSS2 fused with exon 4 of ERG gene). No fusion gene expression was detected in the 50 normal donor patients. EGFR, PSCA, and CK19 also showed up-regulation in the cancer patients compared to the normal donors, but the gene expression pattern was less specific compared to that of PSA, SPDEF, AR, AGR2, T1E2, and T2E4. HER2 and PSMA expression, showed no differentiation between the cancer patients and normal population. Both β-Actin and BST1 were abundant in the patient samples purified through CellSearch system. β-Actin is expressed in all cell types, while BST1 is specific to leukocytes. The correlation of expression between these 2 genes was 0.97. The detection of BST1 expression demonstrated that the cells purified through the CellSearch system had a significant amount of leukocyte carryover, as shown by others. The highly correlated expression profile between β-Actin and BST1 also meant that the expression of β-Actin mainly contributed by carry-over leukocytes.

### i. PCA and Unsupervised Clustering Analyses

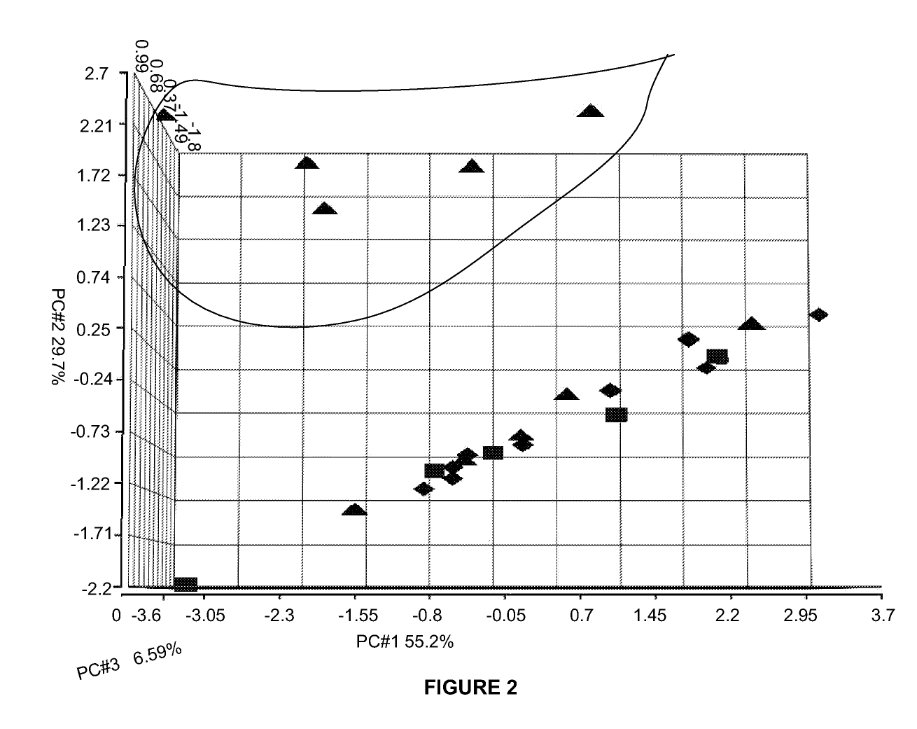

PCA analysis was performed with the expression data of PSA, AR, AGR2, SPDEF, T1E4, and T2E4, as shown in FIG. 2 after excluding patients on salvage therapy. There were clearly two distinct group of patients formed due to their gene expression profile differences. The 5 patients, as circled in the figure, all had the expression of the fusion gene.

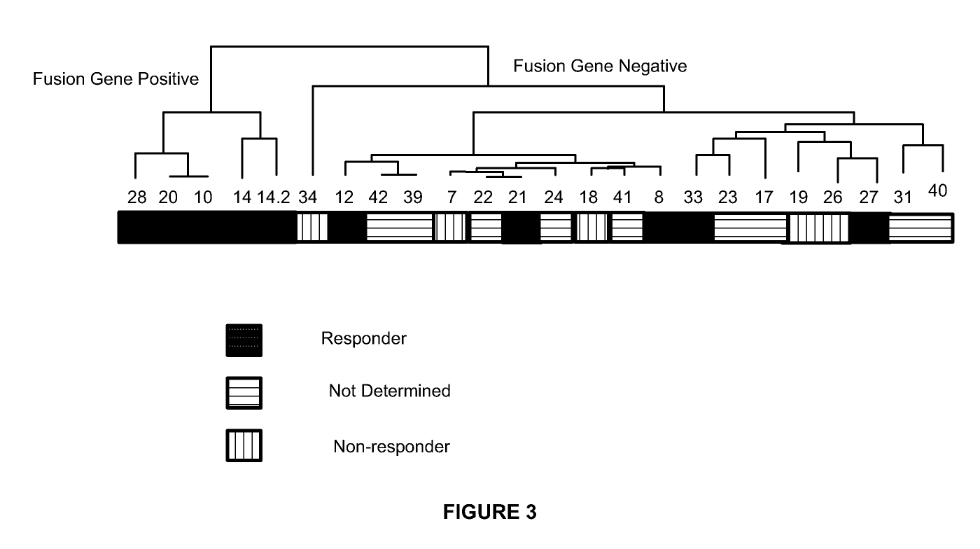

Unsupervised clustering analysis separated the patients into 3 major clusters, shown in FIGS. 3(a) and 3(b). The same 5 patients grouped together in the PCA analysis formed one cluster and these five patients treated with either Docetaxel or Docetaxel plus RAD001 responded to the therapy.

j. Discussion

The presence of CTCs in patient bloods has been shown to be a prognostic factor, and post therapy changes in CTC number are associated with patient overall survival, respectively in patients with breast cancer. Quantitative RT-PCR is a very sensitive and specific method to assess candidate gene expression and has been commonly used for research purposes and clinical applications. This approach has been used in combination with CTC enrichment for specific gene expression evaluation, detection and quantitation of CTCs. This data demonstrates that cells isolated from patients with androgen-independent prostate cancer, with an automated CTC capture technology, had molecular features of malignant prostate epithelial cells. 75% of the study patient population had five or more cells identified in 7.5 mL of blood. It should be noted that only five patients had no CTCs detected, and five patients had 4, 2, or 1 CTCs detected. This result demonstrated that the percentage of patient having CTCs is high in this study population and in line with what other researchers have observed, and further confirmed the sensitivity and reliability of the CellSearch system.

The capability of evaluating candidate gene expression levels in purified CTC population is demonstrated using quantitative RT-PCR. The majority of the 40 patients had over-expression of AR, PSA, AGR2, and SPDEF. These genes have been shown to be more specific to prostate epithelial cells and their up-regulation was associated with prostate cancer development. The detection of these markers in the isolated CTC population not only confirmed that the CTCs originated from the prostate, but also revealed that the majority of circulating tumor cells in patient blood still kept the properties of prostate cells. About 40% of the patients had over-expression of EGFR, and 55% of the patients had PSCA up-regulated. The significance of this relationship remains under investigation. The median expression level of HER2 and PSMA was no different between the cancer patient group and the normal donors. This observation could be due to the fact that expression of HER2 and PSMA are not specific to the cancer epithelial cells. With leukocyte carryover (contamination), RT-PCR may not be a good measurement for expression of these transcripts. We also observed that BST1, a white blood cell specific marker, was expressed at a low level in the majority of normal donor and metastatic prostate cancer patient samples. This result was concordant with the observation of leukocytes present in the CTC-enriched cell population. The numbers of leukocytes identified ranged from several hundreds to several thousands. The leukocyte contamination or co-purification with CTCs affects the analytical sensitivity of CTC-specific genes and creates a problem for detecting genes that are not specific for CTCs but are important drug response or cancer stem cell markers. Also, whole genome profiling of CTCs becomes problematic if the CTC number is low. Further improvements on the CellSearch system or additional reduction procedures are needed for more sophisticated molecular analyses.

Many genetic changes and molecular alterations have been identified in prostate cancer, and some of these have been proposed as possible risk and disease progression biomarkers. Chromosomal translocations and gene fusions involving members of the ETS family of transcription factors are significant events in prostate cancer. The androgen-regulated gene TMPRSS2 fused with ERG is the most common type of genomic translocation, and about 60% of the fusion events are due to a deletion of 3 Mb between TMPRSS2 and ERG. The clinical significance of TMPRSS2-ERG fusion events has been controversial in prostate cancer. Perner et al. published a study that correlated prostate cancers with TMPRSS2-ERG fusion to higher stage and frequency of pelvic lymph node metastases. Demichelis et al. have also demonstrated that the rearrangement was associated with metastasis or prostate cancer specific death. On the other hand, the expression of the fusion gene was found to be an independent predictor of favorable outcome in a multivariate analysis of patients treated with radical prostatectomy. A recent study showed that the presence of the fusion gene was significantly associated with lower grade cancers and that the deletion was significantly associated with the absence of seminal vesicle invasion.

This study shows that the patients with either T1E4 or T2E4 fusion gene expression had distinct expression patterns by PCA and unsupervised clustering analyses. Five patients in this category received Docetaxel-based therapy and all 5 of these patients responded to the therapy.

The treatment outcome for these patients is very promising and suggests that TMPRSS2-ERG fusion gene expression is a predictor of Docetaxel treatment response.

In summary, the gene expression level of AR, PSA, AGR2, SPDEF, T1E4, and T2E4 in isolated CTCs has been successfully evaluated. Surprisingly, a novel finding is that the expression of the fusion gene appears to somehow be associated with Docetaxel treatment response in this patient population and that too with a specificity of 100%, which is promising for stratifying patients with high specificity for more effective treatment.

### 2. Example 2

### Cell Types and Protein Markers Related to Angiogenesis Based Stratification

This example shows that Tissue Factor (TF), and/or a cell type marker of vascular damage, circulating endothelial cells (CEC) (potentially angiogenesis related markers) or changes in their levels immediately following treatment, are prognostic for OS in patients with castration resistant prostate cancer (CRPC)—which is effectively the same as AIPC—from several markers investigated. In addition, combining these markers with CTC allows construction of a predictive nomogram for treatment outcome. It may be noted that TF and endothelin-1 (ET-1), another marker with a role in angiogenesis, are known angiogenic agents. Described, then, is a method of utilizing CEC, CTC and TF levels alone and in combination to predict OS early on in CRPC patients being treated with docetaxel-based therapy.

CEC per 4.0 mL, CTC per 7.5 mL of blood, and serum concentrations of ET-1 (pg/mL) and TF (pg/mL) were assayed in 162 patients treated with a docetaxel containing regimen. Blood was drawn before, at 2-5 weeks, and 6-8 weeks of treatment. Baseline CTC predicted OS while baseline CEC, TF, and ET-1 were not prognostic. However, a >3.8 fold increase in CEC 2-5 weeks after initiation of therapy was associated with decreased OS (median 10.9 vs. 16.8 months; P=0.015), as was any decrease in TF levels when compared to baseline levels (median 11.9 vs. 21.5 months; P=0.0005). CTC counts at 2-5 weeks were also predictive of decreased OS (median 10.4 vs. 17.4 months; P=0.0002). Combining CTC with changes in TF and CEC 2-5 weeks after treatment initiation yielded four groups differing in OS (median OS 24.2 vs. 16.0 vs. 11.4 vs. 6.1 months; P<0.0001).

The presence of circulating tumour cells (CTC) prior to and during therapy predicts OS in patients with metastatic breast, colorectal or prostate cancer. Although PSA has traditionally been used to monitor treatment, CTC counts have been shown to outperform serum concentrations of PSA as predictor of OS. More recently, both tumour- and vascular derived markers have been investigated for this purpose.

Several studies suggested that both markers of angiogenesis or vascular damage could be of prognostic value in prostate cancer. For example, quantifying angiogenesis by histological assessment of microvessel density, has been shown to be independently associated with survival in prostate cancer. But this approach requires an invasive procedure, is time consuming, and therefore less practical in clinical use. Alternative indicators of angiogenesis such as soluble serum proteins ET-1 and TF have not yet been examined in depth in prostate cancer.

ET-1 acts synergistically with Vascular Endothelial Growth Factor (VEGF) and is secreted primarily by vascular endothelial cells. Following binding to the endothelin A receptor, it induces endothelial cell proliferation, invasion, and tubule production. Levels of ET-1 are associated with microvessel density in several forms of cancer, including breast, colorectal, and ovarian cancer. TF is a transmembrane glycoprotein derived from platelets, endothelial cells and leukocytes, which is involved in coagulation and tumor neovascularization. After splicing, it can be measured in the peripheral blood. Both ET-1 and TF receptor antagonists are currently being investigated as anti-angiogenic treatments. CEC are also a promising biomarker with potential prognostic value in cancer patients. CEC are mature endothelial cells that have detached from the vessel wall and are considered a marker of vascular damage.

a. Patients and Methods

### i. Patients

Blood samples were collected from 231 patients with CRPC by venesection into 2×10 mL CellSave tubes (Veridex, LLC, Raritan, N.J.) and 1×6 mL serum tube in a multi-center prospective study. One CellSave tube was used to determine the number of CTC for prediction of OS. Results on CTC levels measured in this group have been previously published. The second collected CellSave tube was used to determine CEC numbers.

In order to assess a homogenous group of patients with respect to systemic therapy, we selected all who were scheduled to receive docetaxel or a docetaxel containing regimen (n=162) from the 231 patients. Treatment was continued until progression or unacceptable toxicity. Demographics of the patients included in the present study are shown in Table 4. Main eligibility criteria included age ≧18 years, pathological diagnosis of adenocarcinoma of the prostate, first or later line of chemotherapy, serum testosterone <1.7 nmol/L (50 ng/mL), Eastern Cooperative Oncology Group (ECOG) performance status 0-2, pretreatment serum PSA≧5 ng/mL, PSA progression (rises above a reference value) despite androgen deprivation therapy, and ability to sign informed consent. This study was approved by the local Institutional Medical Ethical Review Boards and is in agreement with the Helsinki declaration of 2000. Written informed consent was obtained from all patients prior to participation.

CEC and CTC counts were determined prior to initiation of chemotherapy and after 2-5 weeks (first follow-up draw) and 6-8 weeks (second follow-up draw) of treatment. Serum concentrations of ET-1 and TF were also determined at these same time points. Prior to treatment, all patients had a complete blood count analysis and assessment of serum concentrations of lactate dehydrogenase (LDH), alkaline phosphatase (Alk. Phos), haemoglobin and albumin.

### ii. Enumeration of CTC and CEC

The CellTracks® AutoPrep® and CellTracks Analyzer II® Systems (both Veridex, LLC, Raritan, N.J.) were used to count CTC and CEC. CTC were defined as intact cells positive for the nuclear stain 4′ 6-diamidinophenylindole (DAPI), the epithelial cell adhesion molecule (EpCAM), and for cytokeratins 8, 18 and 19 that also lacked expression of the panleukocyte marker CD45. CEC were identified as intact cells positive for DAPI, CD146 and CD105 that also lacked expression of CD45.

The technical details of both assays have been published previously. CTC numbers are reported as cells/7.5 mL of whole blood and CEC numbers as cells/4.0 mL of whole blood.

### iii. Assessment of Serum Levels of TF and ET-1

Serum concentrations (pg/mL) of ET-1 and TF-1 were determined by ELISA. The ET-1 specific ELISA was purchased from Assay Designs (Ann Arbor, Mich., USA) and used according to the manufacturers' instructions. The TF specific ELISA was purchased from AssayPro (St. Charles, Mo., USA). To improve the sensitivity of this assay, samples were diluted twofold rather than the fourfold as suggested by the manufacturer. Absorbance was read at 450 nm using a Titertek 212 MS microplate reader (Titertek, Huntsville, Ala.). Samples were tested in duplicate and related to the standard curves for each assay. The lower detection limits of the assays were 1.3 pg/mL for ET-1 and 20.0 pg/mL for TF.

### iv. Statistical Analysis

Longitudinal biomarker data were analyzed using a random effects linear regression model using the maximum likelihood random effects estimator (the “xtreg, mle” command in STATA). This was done to incorporate both between- and within-subject effects as well as random effects and to assure that the observed alterations in biomarkers was not the result of inter-individual differences. Because the biomarker values were skewed (i.e. non-normally distributed), a logarithmic transformation was applied (CTC values of zero were added a constant of 1 prior to transformation) prior to the regression analysis. OS was defined as the time (in months) between the first blood draw and the date of death or last contact. Kaplan-Meier survival plots were made using stratified (i.e. categorical) data. For CTC numbers, a cutoff value of >5 CTC/7.5 mL was used. To determine a cutoff value for survival analysis of CEC numbers and serum concentrations of ET-1 and TF, patient data were first stratified according percentiles (p0-p25; p25-p50, p50-p75, and p75-p100), in which either their baseline value or the change between baseline values and those determined at 2-5 weeks would fall. (Both baseline and 2-5 weeks values and changes between baseline and 2-5 weeks were analyzed separately). In case of a clear outlier, determined by inspection of the four strata in the Kaplan-Meier plots, the percentiles were used to dichotomize the data in such a way that the overlapping percentiles were grouped together, and the value defining the separating percentile was used as stratifier. In case no clear outlier could be observed, the median value for either the measurement at the time-point or for the change in the value between time-points were used as stratifier. The logrank test was used to compare survival between strata. Univariate Cox proportional-hazards regression was used to identify baseline parameters associated with survival. Significant baseline parameters (i.e. p-values <0.05) were subsequently used in multivariate analysis. The predictive accuracy of the multivariate Cox models were assessed by concordance analysis and reported as Harrel's C index. Data are reported as mean±standard deviation (SD) unless stated otherwise. All analyses were performed using STATA v10 software (StataCorp., College Station, Tex., USA).

b. Results

### i. Alterations in CEC, CTC, ET-1 and TF Levels During Treatment

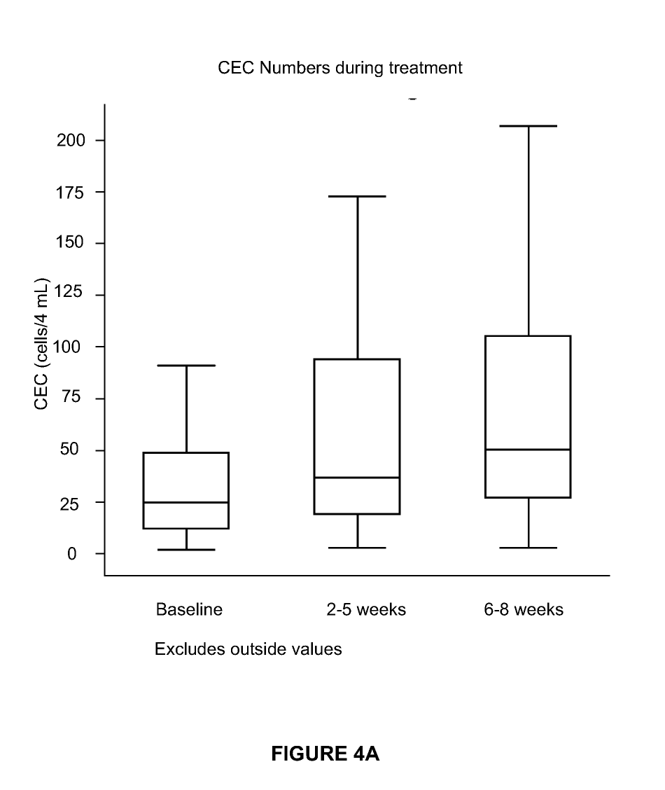

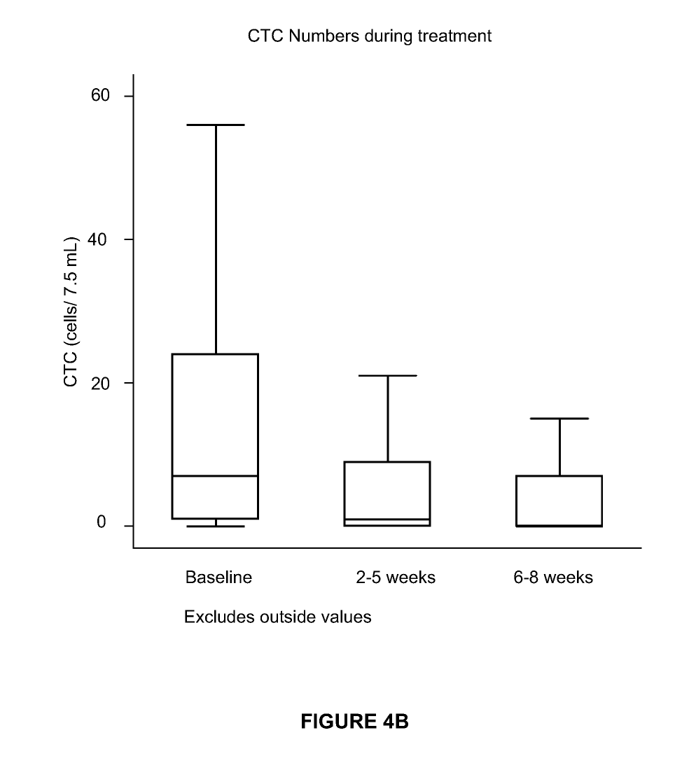

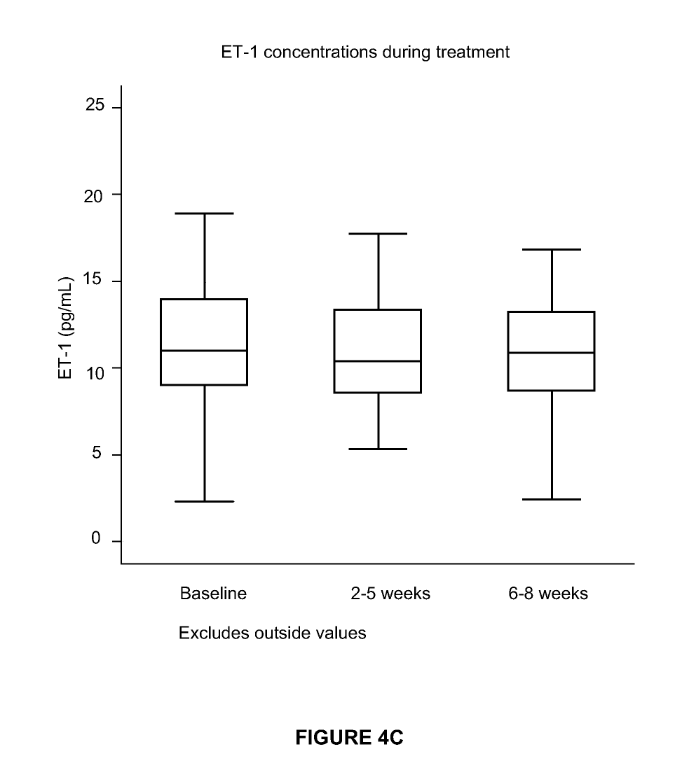

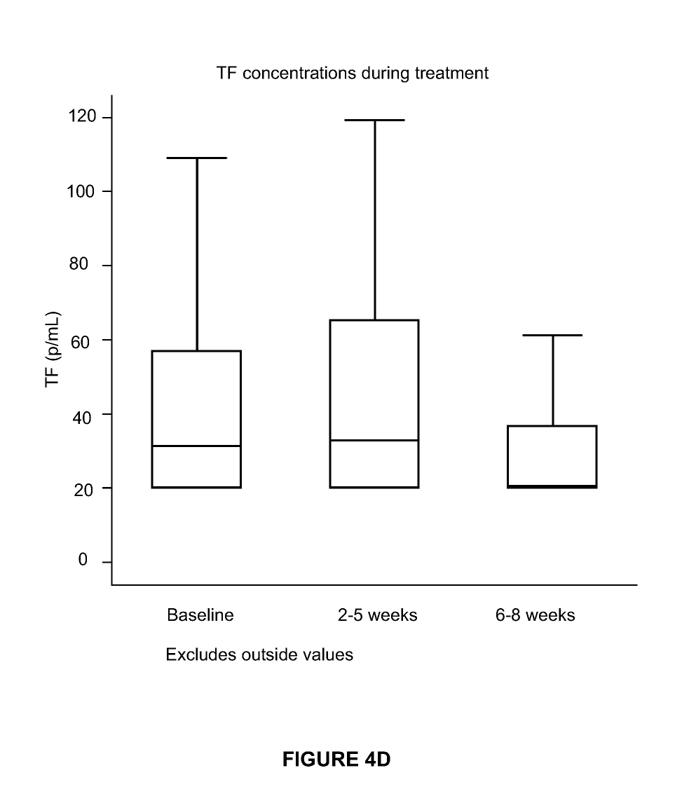

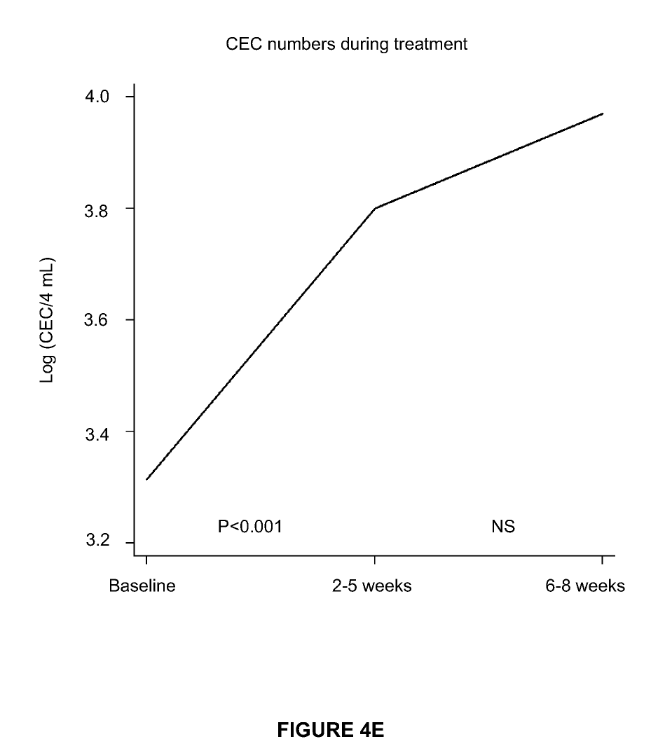

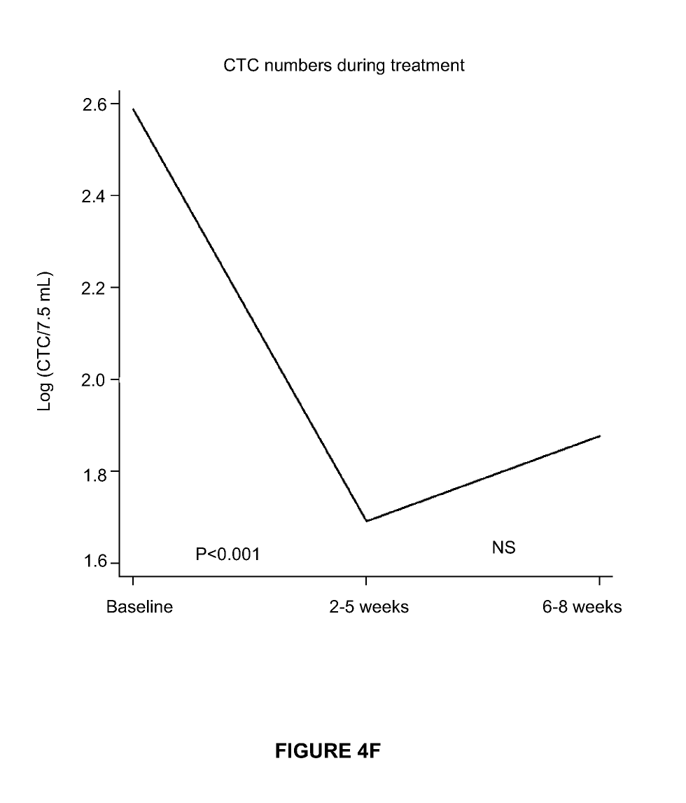

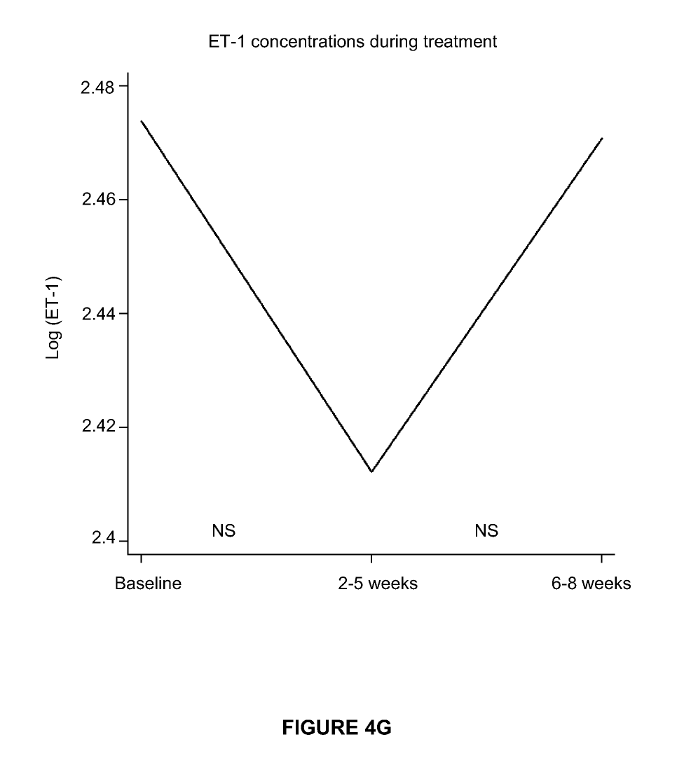

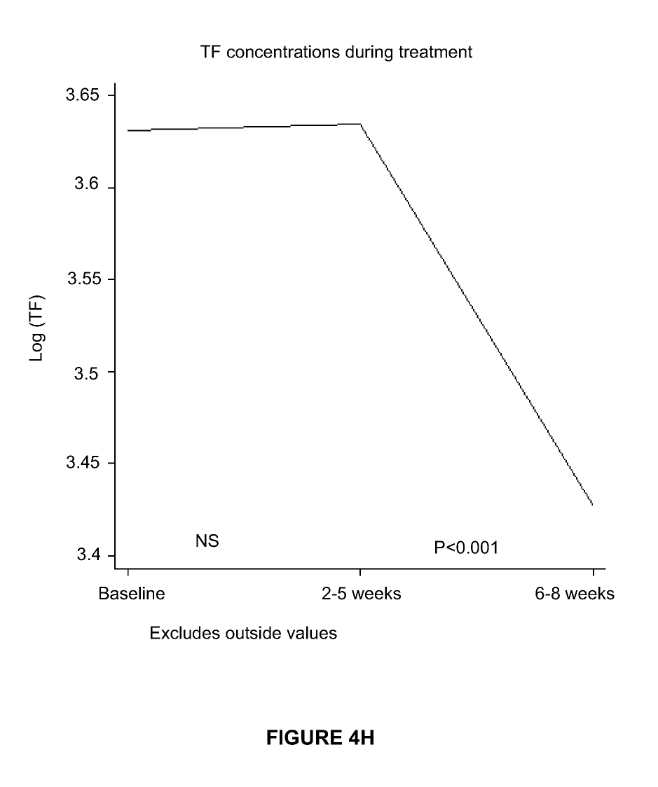

Baseline levels of CEC, CTC, ET-1, and TF are shown in Table 4. A significant increase in CEC numbers was observed at the first follow-up blood draw, taken 2-5 weeks after initiation of docetaxel, when compared to baseline. No further increase was found at the second follow-up draw, taken 6-8 weeks after treatment initiation. Repeated linear regression for longitudinal data, performed to correct for inter-individual variation in CEC numbers, confirmed the significant general increase in CEC numbers after 2-5 weeks of treatment (FIG. 4, panel A and E). No additional significant change was observed after 6-8 weeks of treatment. The CTC numbers from the subgroup of patients included in this study are depicted in FIG. 4, panels B and F. CTC decreased significantly after 2-5 weeks of treatment but remained stable thereafter. In contrast to serum concentrations of ET-1, which remained constant during docetaxel treatment (FIG. 4, panels C and G), a significant decrease of TF was observed after 6-8 weeks of therapy compared to baseline and first follow up draw (FIG. 4, panels D and H).

### ii. Early Changes in CEC, CTC and TF Levels are Prognostic for Poor Overall Survival

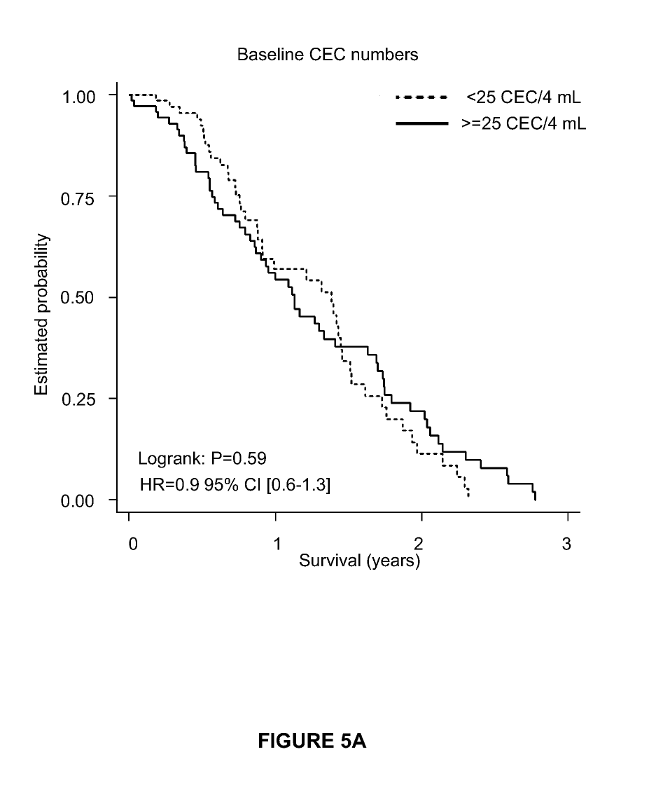

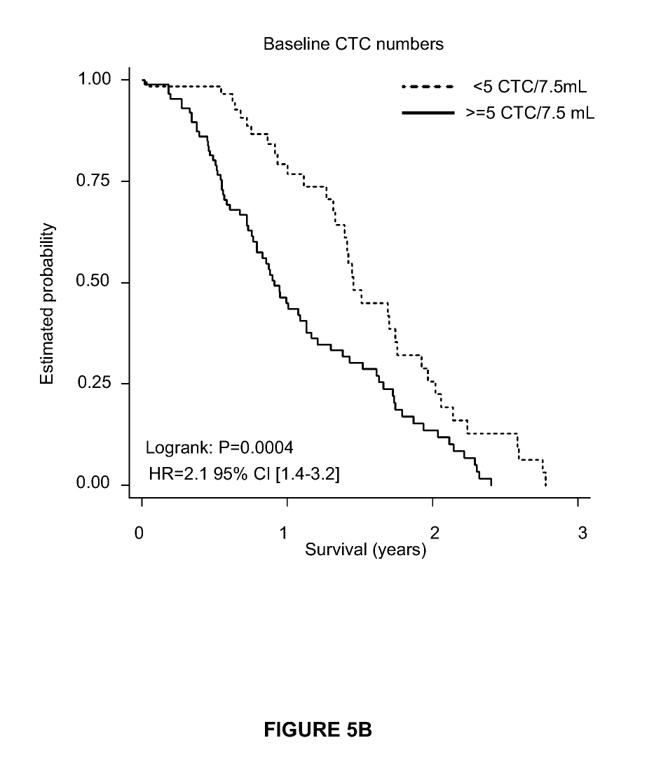

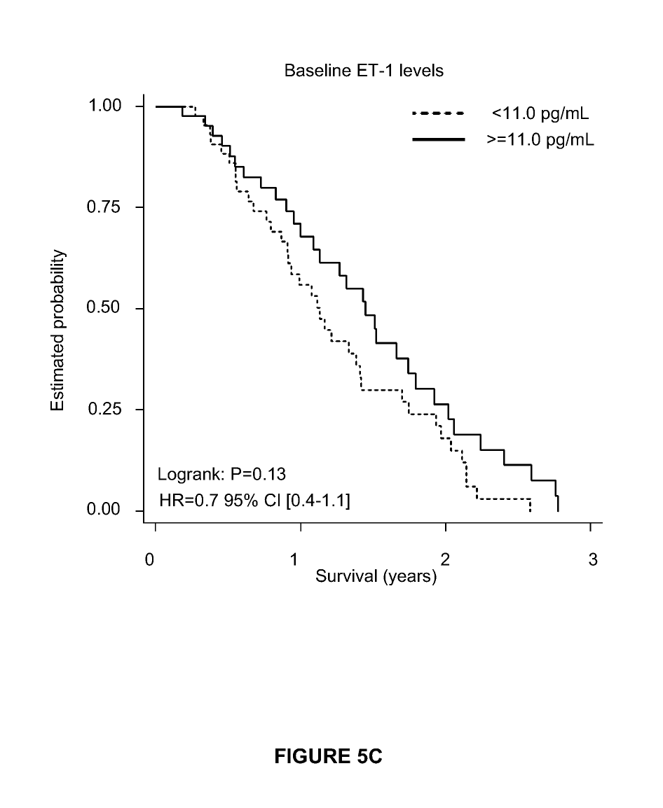

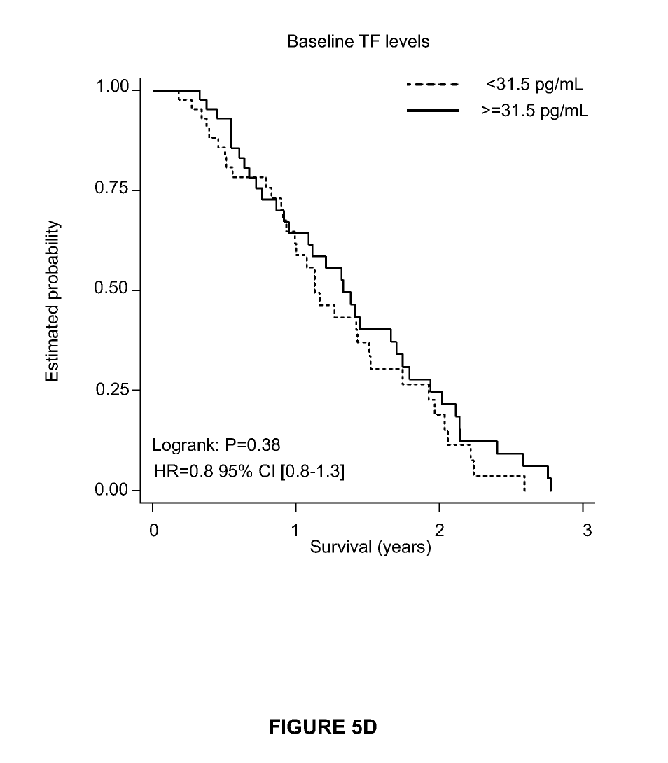

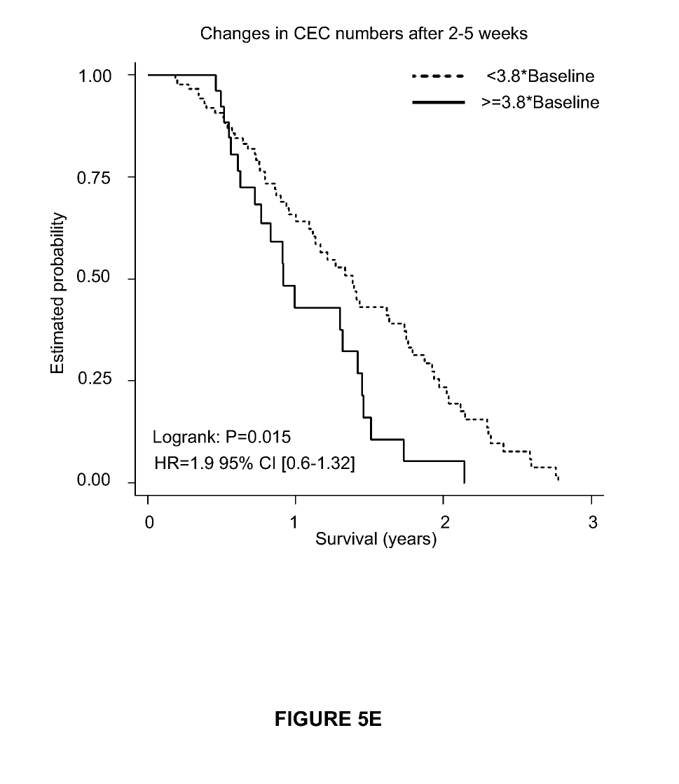

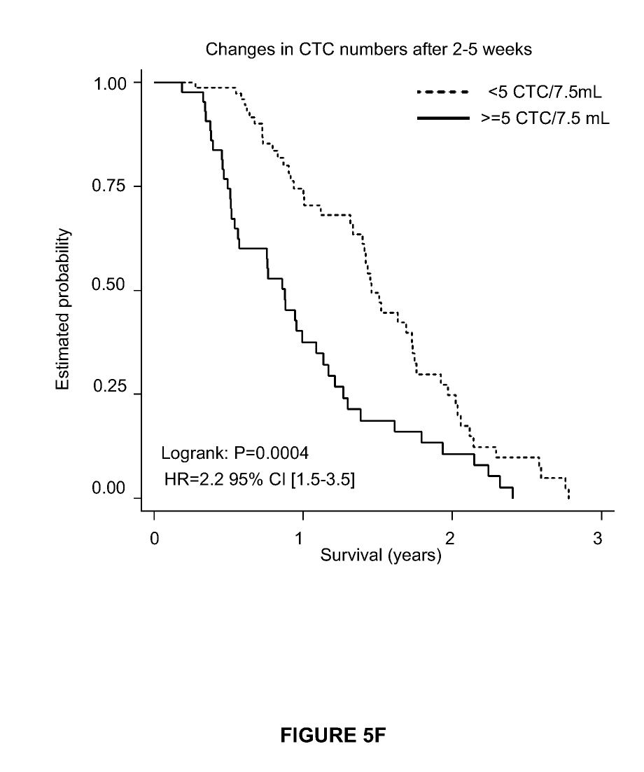

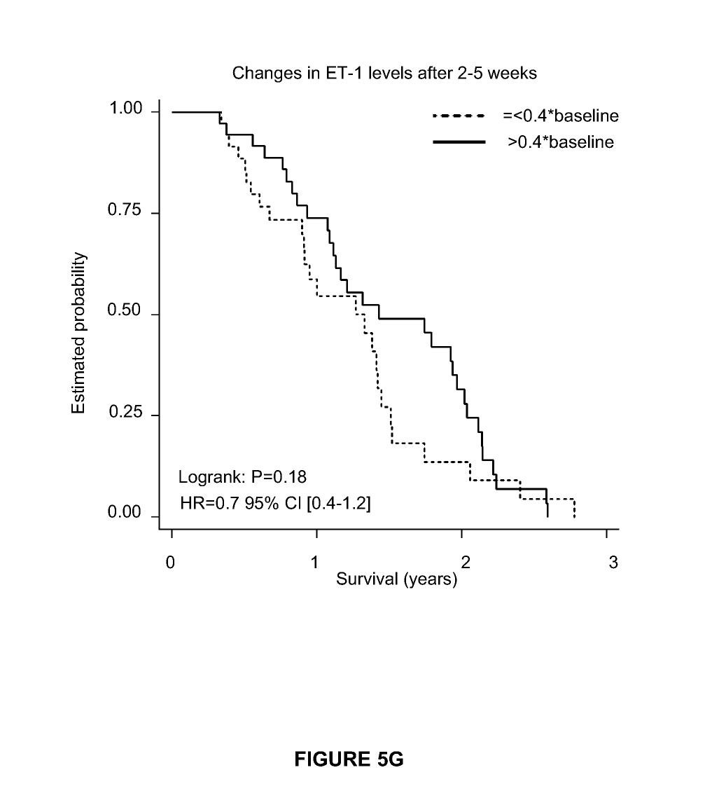

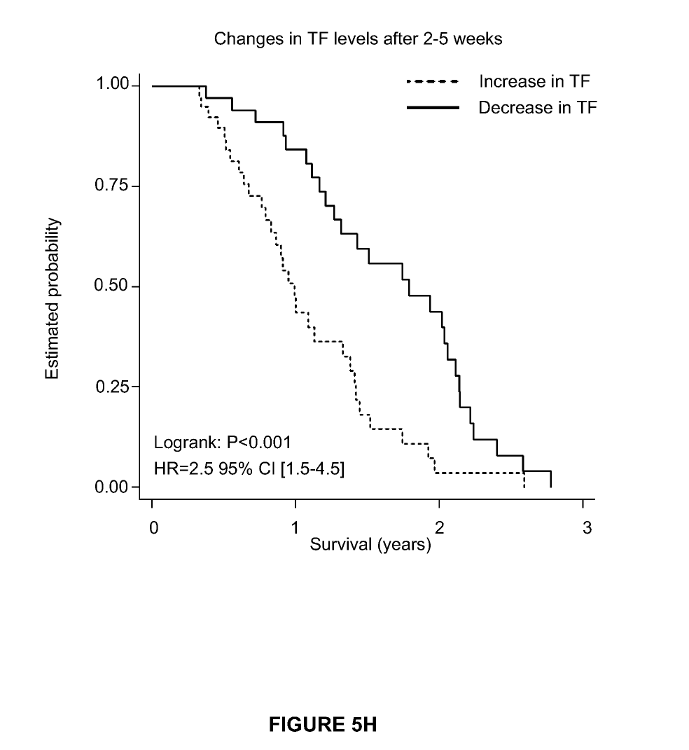

After dichotomizing data around their median baseline values, no prognostic value for OS could be determined for baseline levels of CEC, ET-1 or TF (FIG. 5, panels A, C and D, respectively). Similar to results reported for the whole group 5, baseline CTC numbers ≧5 cells/7.5 mL in the subgroup included in the present study were associated with significantly decreased OS when compared to patients with baseline CTC numbers <5 cells/7.5 mL (10.9 vs. 17.4 months, respectively; P=0.0004, FIG. 5, panel B). With respect to CEC, analyses with various percentiles of the ratio between CEC at 2-5 weeks and CEC at baseline revealed that patients in the p75-p100 percentile (i.e. >3.8 fold increase in CEC at 2-5 weeks), showed significantly worse outcome compared to those with a more limited CEC increase (FIG. 5, panel E). Median survival for patients with >3.8 fold CEC increase at 2-5 weeks was 10.9 months compared to 16.8 months for those with a fold CEC increase of <3.8 (P=0.015). Although no significant overall difference could be observed between baseline TF levels and ET-1 levels at baseline and after 2-5 weeks of treatment (FIG. 4, panels C, D and G), we found a significantly worse OS in those patients in whom a decrease in TF concentrations was observed after 2-5 weeks of treatment (FIG. 5, panel H; median OS 11.9 months vs. 21.5 months; P<0.001). Alterations after 6-8 weeks were not associated with survival.

Additionally, whether or not the combined use of all markers assessed in this study were found to be prognostic for decreased OS, i.e. CEC and CTC numbers and TF levels, additional information on survival after 2-5 weeks of treatment was also assessed. Sixty-nine patients were eligible for this combined analysis, meaning that all clinical and laboratory data was available.

First, possible relation between each prognostic marker by both uni- and multivariate regression analysis was assessed. No significant associations were found, implying the independent prognostic value of each factor (data not shown).

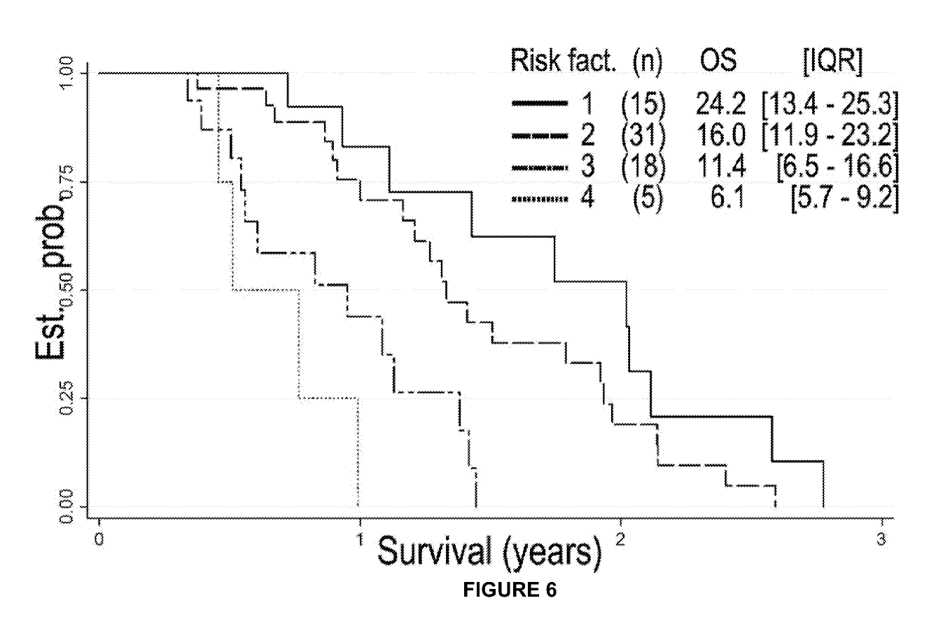

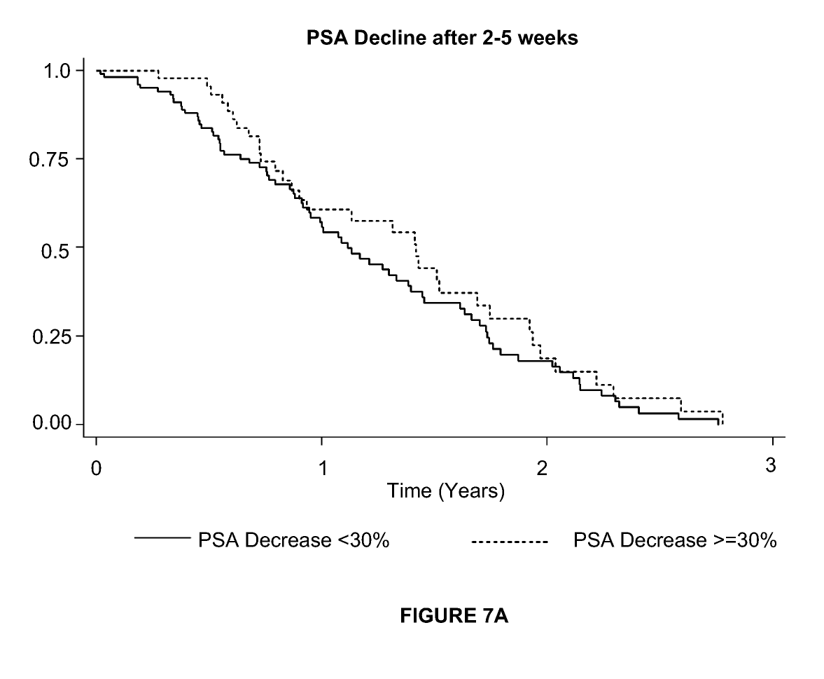

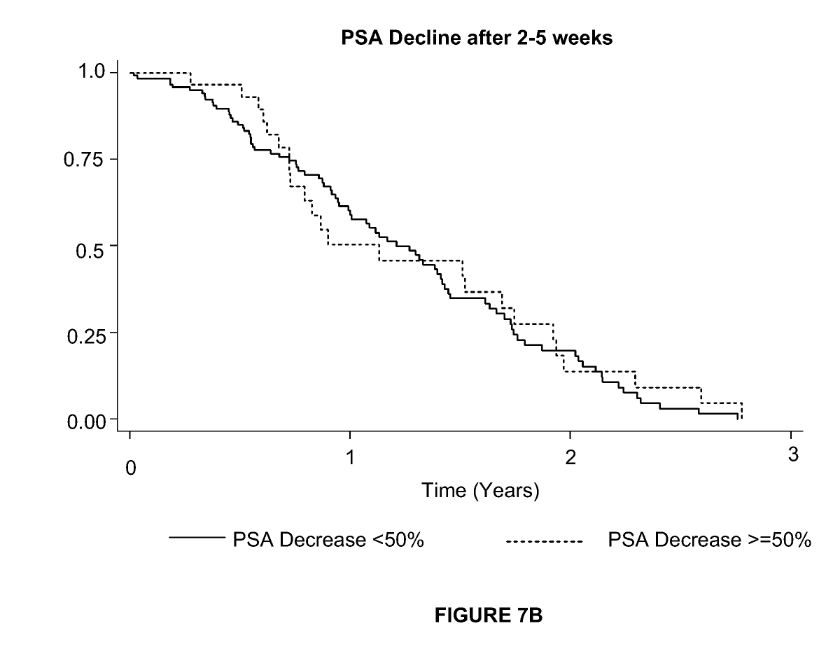

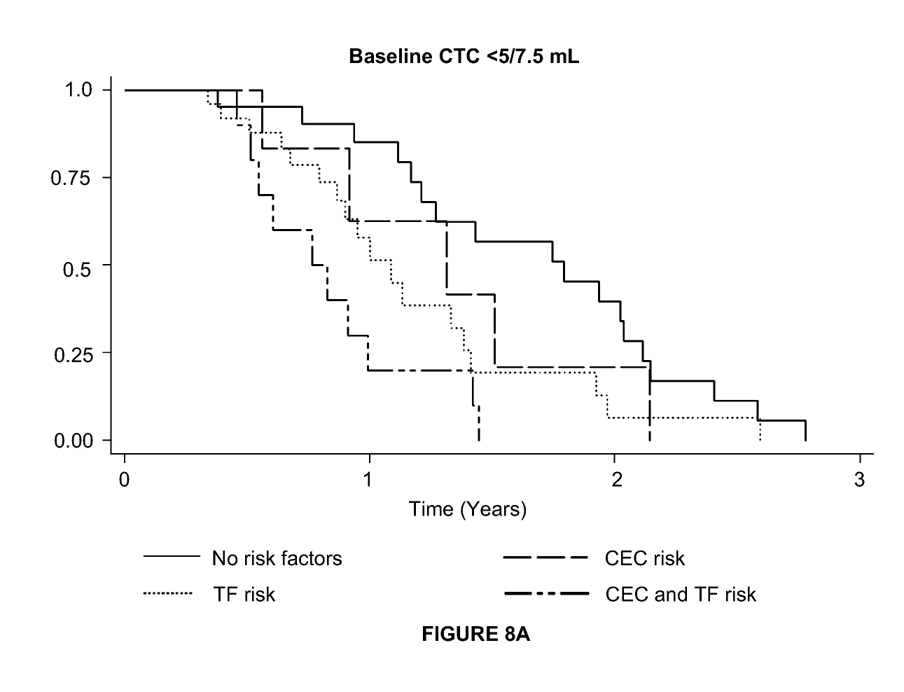

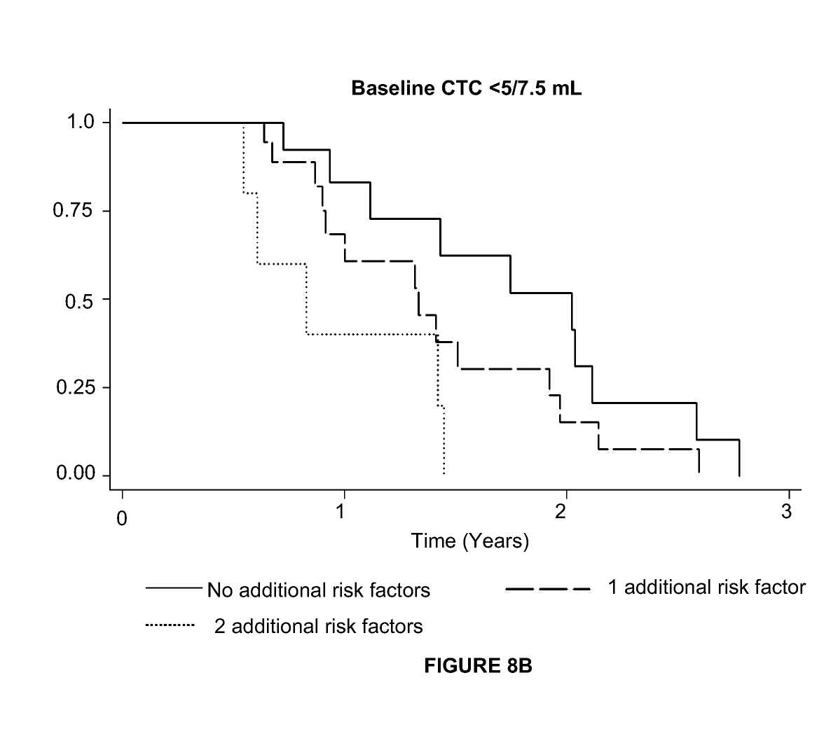

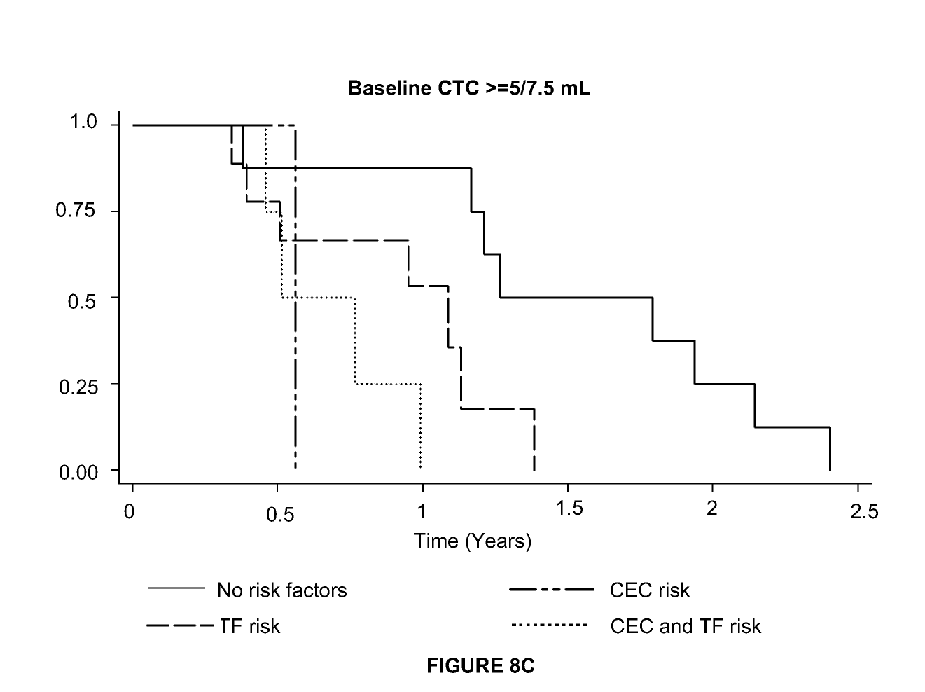

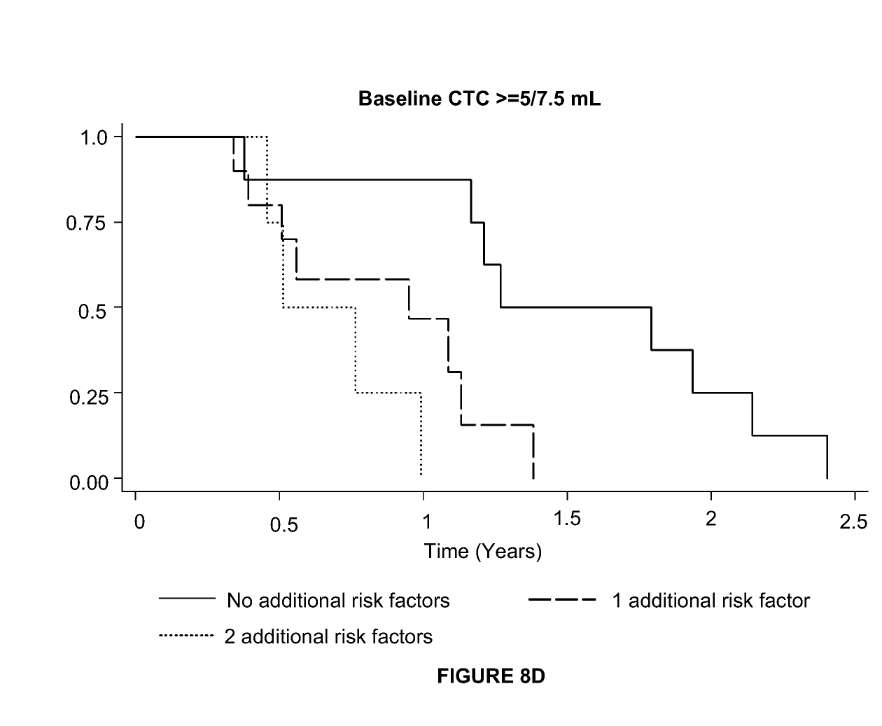

Next, patients were stratified based on the number of risk factors for poor survival present after 2-5 weeks of treatment, namely an increase in CEC numbers >3.8 times the baseline counts, any decrease in TF levels when compared to baseline counts, and CTC counts of >5 per 7.5 mL of blood. Here, a significant decrease in OS was found as the number of risk factors present increased (Logrank test for trend P<0.0001). All data for this analysis is shown in FIG. 6. Also shown for CTC counts of <5 per 7.5 mL of blood is the performance in predicting OS of additional risk factors reduction in TF and an increase in CEC over 3.8 cells and combinations thereof in FIG. 8A; and the performance in predicting OS of additional 0, 1 and 2 additional risk factors selected from reduction in TF and an increase in CEC over 3.8 cells in FIG. 8B. Further for CTC counts of >=5 per 7.5 mL of blood is the performance in predicting OS of additional risk factors reduction in TF and an increase in CEC over 3.8 cells and combinations thereof in FIG. 8C; and the performance in predicting OS of additional 0, 1 and 2 additional risk factors selected from reduction in TF and an increase in CEC over 3.8 cells in FIG. 8D.

As is seen, independent of CTC counts, the identified additional markers are effective in improving the prediction of OS.

### iii. CEC and TF Levels Increase the Prognostic Accuracy of CTC at 2-5 Weeks

To determine which parameters would provide the most accurate survival model, the following procedure was performed although alternative approaches are within the scope of this description. First, all parameters presented in Table 4 that were prognostic at baseline using univariate Cox regression analysis (results shown in Table 5) were identified. For CEC, TF, and ET-1 levels, the changes after 2-5 weeks of therapy were also univariately evaluated. Parameters found to be significant, which included CTC levels at 2-5 weeks as well as changes in CEC, CTC and TF levels were subsequently used in a multivariate analysis (Table 6). Three risk factors were found to be independently significant in the multivariate analysis; namely CTC counts of ≧5 cells/7.5 mL at 2-5 weeks, a ≧3.8 increase in CEC from baseline to 2-5 weeks, any decrease in TF levels at 2-5 weeks. To assess whether patient stratification yielded a more accurate survival model than the combined use of each individual prognostic parameter, a concordance analysis, which results in a C index was performed. Briefly, the C index describes how accurately does the Cox regression model predicts survival, where a C index near 0.5 means that the model does not predict survival and values approaching 1.0 indicate that the model nearly always predicts if a patient has a better prognosis 24. It was discovered that the stratification based on the number of risk factors present resulted in an increased predictive power fit of the Cox proportional-hazards regression model (Table 7).

### iv. PSA Declines after 2-5 Weeks of Treatment are not Prognostic for Poor Overall Survival

Also analyzed were the baseline levels of prostate specific antigen (PSA) and decreases in PSA at 2-5 weeks of both 30% and 50% when compared to the baseline values using identical patient stratification as used for the CEC, CTC and soluble marker analyses. A decreased OS for patients with baseline PSA levels >493 ng/mL (median 9.5 months vs. 16.6 months; P=0.002) was observed. Neither a 30% nor 50% decrease in PSA levels at 2-5 weeks after start of docetaxel was associated with OS in this cohort (See FIGS. 7A & 7B).

c. Discussion

In CRPC patients, docetaxel combined with prednisone is currently the only treatment that has been shown to yield an OS benefit in randomized studies. However, the gain in OS is relatively modest given a median prolongation of only 2 months compared to mitoxantrone and prednisone, which comes at the expense of potential severe side-effects. With this in mind, many unsuccessful attempts have been made to identity CRPC patients at risk for rapid progression and poor survival.

PSA, the most widely explored marker, for tracking disease progression has been inadequate. Multivariate analysis on baseline PSA levels obtained from the TAX327 study in CRPC in which docetaxel with prednisone was randomly compared to mitoxantrone with prednisone, demonstrated increased OS for patients with a baseline PSA<114 ng/mL when compared to those with higher levels 25. Data from the same study allowed the development of a predictive nomogram for survival. Using baseline parameters such as PSA, LDH, alkaline phosphatase and hemoglobin concentrations, patients likely to have decreased survival could be identified. In this study, the prognostic value of baseline PSA levels was confirmed (as opposed to changes in PSA) but found no prognostic value of baseline CEC, ET-1, or TF levels for survival.

In addition to a marker that provides information on OS prior to initiation of chemotherapy, there is also a great need for markers that discriminate at an early stage during therapy those patients who clearly benefit from chemotherapy from those who do not. Previously, it was demonstrated that a PSA decrease of 30% after 3 months of treatment was a good surrogate marker for survival in patients treated with docetaxel/estramustine or mitoxantrone/prednisone. Similar results were observed in the TAX 327 study²⁵.

In the current study, a >3.8 fold increase in CEC after 1 or 2 cycles of docetaxel was found to be prognostic for decreased OS. CEC numbers may reflect the extent of vascular damage as several studies have shown an anti-vascular effect for both paclitaxel and docetaxel in vitro and in murine models. If this holds true for humans as well, then the rise in CEC numbers, which was seen in all patients, may be the result of vascular damage inflicted by docetaxel. The additional CEC increase in patients with the worst OS may be attributed to the continued endothelial cell shedding from vessels due to tumor progression during treatment. Furthermore, an increase in TF concentration during the first 2-5 weeks of treatment was found to be associated with a better survival, whereas alterations at 6-8 weeks were not associated with survival. Without being bound by theory, this observed association may the result of massive shedding from apoptotic tumour cells, which, similar to platelets, endothelial cells and leukocytes, have also been reported to express TF 30. As previously reported for the whole group from which the subgroup presented in this study was selected⁵, CTC counts of ≧5/7.5 mL 2-5 weeks after the initiation of treatment were associated with a poor prognosis.

The evaluated markers probably represent different processes involved in tumour progression. Whether or not their combined use could aid clinicians in classifying docetaxel-treated CRPC patients into groups differing in OS was also explored. Concordance analysis demonstrated that the use of CEC, CTC and TF levels are independent risk factors for OS. Importantly, their combined use after 2-5 weeks yielded four groups with statistically different and clinically relevant differences in OS (median OS: 24.2 vs. 16.0 vs. 11.4 vs. 6.1 months). Interestingly, at this same time point, PSA values were not informative for OS. The risk stratification method described herein outperforms PSA levels as early markers for ultimate outcome during docetaxel-based chemotherapy in CRPC. Although the number of patients with a decreased OS survival in our study was relatively small, the results are promising.

TABLE 4
Patient demographics and laboratory parameters

| Parameter | Baseline | Wks 2-5 | Wks 6-8 |
|---|---|---|---|
| N | 162 | 134 | 89 |
| Time from baseline | | | |
| (days) | | | |
| Mean ± SD | 0 | 26.6 ± 6.7 | 47.7 ± 6.6 |
| Range | 0 | 19-41 | 42-61 |
| Age (years) | | | |
| Mean ± SD | 69.8 ± 9.6 | | |
| Range | 45-92 | | |
| Race | | | |
| White | 148 | | |
| Black | 11 | | |
| Other | 3 | | |
| ECOG status | | | |
| 0 | 74 | | |
| 1 | 71 | | |
| 2 | 12 | | |
| Unknown | 5 | | |
| Stage at diagnosis | | | |
| 1 | 9 | | |
| 2 | 24 | | |
| 3 | 39 | | |
| 4 | 13 | | |
| Unknown | 77 | | |
| Gleason score | 7.1 ± 1.5 | | |
| Mean ± SD | 7.1 ± 1.5 | | |
| Range | 2-10 | | |
| Prior local radiation | | | |
| Yes | 66 | | |
| No | 96 | | |
| Prior surgery | | | |
| Yes | 103 | | |
| No | 59 | | |
| Prior chemotherapy | | | |
| Mitoxantrone | 24 | | |
| Estramustine | 5 | | |
| Gemcitabine | 3 | | |
| Carboplatin | 3 | | |
| None | 127 | | |
| Line of chemotherapy | | | |
| 1 | 126 | | |
| 2 | 20 | | |
| 3 | 12 | | |
| >=4 | 4 | | |
| Site of metastasis | | | |
| Bone Involvement | 147 | | |
| Visceral | 65 | | |
| Baseline hemoglobin | 12.4 ± 1.5 | | |
| (g/dL) [N = 159] | | | |
| Baseline LDH | 287 ± 212 | | |
| (IU/mL) [N = 152] | | | |
| Baseline Alk. Phos. | 238.7 ± 280.1 | | |
| (IU/mL) [N = 155] | | | |
| Baseline albumin | 4.0 ± 3.0 | | |
| (g/dL) [N = 156] | | | |
| Baseline testosterone | 0.26 ± 0.2 | | |
| (ng/mL) [N = 155] | | | |
| PSA (ng/mL) | 566.5 ± 1832.9 | | |
| N | 162 | 143 | 122 |
| Mean ± SD | 566.5 ± 1832.9 | 428.4 ± 1526.4 | 347.3 ± 1307.4 |
| Range | 1.9-17.800 | 0.3-17420 | 0.3-12940 |
| CEC (cells/4 mL) | | | |
| N | 153 | 134 | 89 |
| Mean ± SD | 75 ± 200 | 102 ± 176 | 94 ± 119 |
| Range | 2-1939 | 3-1102 | 0-701 |
| CTC (cells/7.5 mL) | | | |
| N | 154 | 142 | 118 |
| Mean ± SD | 107.2 ± 534.8 | 22.7 ± 72.6 | 37.0 ± 160.8 |
| Range | 0-5925 | 0-525 | 0-1367 |
| ET-1 (pg/mL) | | | |
| N | 94 | 87 | 80 |
| Mean ± SD | 19.3 ± 52.5 | 14.1 ± 21.9 | 14.9 ± 17.4 |
| Range | 2.3-489.7 | 1.3-200.0 | 2.5-110.9 |
| TF (pg/mL) | | | |
| N | 95 | 88 | 80 |
| Mean ± SD | 46.6 ± 39.3 | 56.0 ± 102.3 | 45.6 ± 98.0 |
| Range | 20.0-243.4 | 20.0-945.9 | 20.0-877.6 |

TABLE 5
Univariate Cox proportional-hazards regression
analysis of baseline characteristics

| | | | | OS Risk from | |
|---|---|---|---|---|---|
| | | Categories | | baseline | |
| Parameter | | Positive | Negative | HR [Cl] | p-value |
| Age at baseline | 62 | ≧70 | <70 | 1.4 [1.0-2.1] | 0.078 |
| Gleason score | 48 | 10-2 | | 1.1 [0.9-1.2] | 0.34 |
| Stage at diagnosis | 5 | 4 vs. 3 vs. | | 0.9 [0.7-1.3] | 0.64 |
| | | 2 vs. 1 | | | |
| ECOG status | 57 | 2 vs. 1 vs. 0 | | 2.1 [1.5-2.9] | <0.001 |
| Line of chemotherapy | 62 | Continuous | | 1.0 [0.8-1.3] | 0.97 |
| Hemoglobin (g/L) | 59 | Continuous | | 0.9 [0.8-1.0] | 0.011 |
| Testosterone (ng/mL) | 55 | Continuous | | 1.1 [1.0-1.0] | 0.62 |
| Albumin (g/dL) | 56 | Continuous | | 1.0 [1.0-1.1] | 0.20 |
| LDH (IU/mL) | 52 | Continuous | | 5.0 [3.2-7.9] | <0.001 |
| Alk. Phos. (IU/mL) | 55 | Continuous | | 1.4 [1.1-1.8] | 0.011 |
| PSA (ng/mL) | 62 | Continuous | | 1.1 [1.0-1.3] | 0.053 |
| Bone metastasis | 60 | Yes | No | 1.0 [1.0-1.0] | 0.51 |
| Visceral metastasis | 61 | Yes | No | 1.2 [0.8-1.8] | 0.39 |
| CEC (cells/4 mL)¹ | 53 | ≧25 | <25 | 0.9 [0.6-1.3] | 0.59 |
| CTC (cells/7.5 mL) | 54 | ≧5 | <5 | 2.1 [1.4-3.2] | 0.001 |
| ET-1 (pg/mL)¹ | 4 | ≧11.0 | <11.0 | 0.7 [0.4-1.1] | 0.14 |
| TF (pg/mL)¹ | 5 | ≧31.5 | <31.5 | 0.8 [0.5-1.3] | 0.39 |

TABLE 6
Multivariate Cox proportional-hazards regression analysis of parameters
prognostic for OS after 2-5 weeks of treatment (N = 63)

OS Risk from baseline

| Parameter | HR [CI] | p-value |
|---|---|---|
| 2-5 Week CTC (≧5 vs. 5 cell/7.5 mL) | 2.0 [1.0-4.1] | 0.047 |
| 2-5 Week CEC (≧3.8 vs. <3.8 fold | 2.3 [1.1-4.6] | 0.022 |
| increase CEC/4 mL) | | |
| 2-5 Week TF (decrease vs. increase | 2.4 [1.1-5.0] | 0.026 |
| from baseline) | | |
| ECOG status (2 vs. 1 vs. 0) | 2.0 [0.9-3.9] | 0.06 |
| Baseline hemoglobin (g/L) | 1.2 [0.9-1.5] | 0.13 |
| Baseline LDH (IU/mL) | 3.4 [1.5-7.7] | 0.003 |
| Baseline AP (IU/mL) | 1.1 [0.7-1.7] | 0.78 |

TABLE 7
Combined use markers adds to the predictive strength

| | HR [CI] | p-value | C index |
|---|---|---|---|
| Individual use | | | |
| 2-5 Week CTC (≧5 vs. 5 cell/7.5 mL) | 2.0 [1.0-3.8] | 0.049 | 0.74 |
| 2-5 Week CEC (≧3.8 vs. <3.8 fold | 2.5 [.2-4.9] | 0.011 | |
| increase in CEC/4 mL) | | | |
| 2-5 Week TF (decrease vs. increase | 2.9 [1.5-5.6] | 0.002 | |
| from baseline) | | | |
| Baseline LDH (IU/mL) | 3.7 [1.7-8.0] | 0.001 | |
| Combined use | | | |
| Risk factors (3 vs. 2 vs. 1 vs. 0) | 2.5 [1.6-3.8] | <0.0001 | 0.76 |
| Baseline LDH (IU/mL) | 3.2 [1.5-6.6] | 0.002 | |

Panels A-D: CEC numbers increased significantly within 2-5 weeks of treatment, whereas CTC numbers decreased. Both remained stable thereafter. No treatment effects on ET-1 levels were observed. Serum TF declined after 6-8 weeks of treatment. NS=not significant.

Panels E-H: To assure that the observed alterations in biomarkers was not the result of inter individual differences; repeated linear regression analyses were performed. This confirmed the reported alterations in biomarker levels.

Panels A-D: No prognostic value for OS could be determined for baseline values of the tested markers but CTC numbers. HR=hazard ratio, HR=hazard ratio determined in univariate Cox proportional-hazards regression. CI=confidence interval.

Panel E-H: At 2-5 weeks, patients with a 3.8 fold increase in CEC counts, with CTC counts ≧5 cells/7.5 mL or with a decrease in TF levels were characterized by a markedly worse OS. Please note that the blue line in panel H denotes a decrease in TF instead of an increase—as is indicated in the key due to a typographical error.

Association of the number of risk factors present at 2-5 weeks (>3.8 fold increase in CEC, a decrease of TF, and a CTC number of ≧5 cells/7.5 mL) with OS. HR=hazard ratio determined in univariate Cox proportional-hazards regression. CI=confidence interval.

The model presented here may serve as a useful tool for clinical trial design and to tailor patient management by helping physicians select and direct specific treatments for individual cancer patients. To the best of our knowledge, these are the first data demonstrating a prognostic value for CEC and TF changes during cytotoxic therapy in a well defined study population. The combined use of CTC number and relative changes in CEC and TF may help physicians identify CRPC patients not responding to docetaxel-based therapy at an early stage during therapy.

3. Conclusion

Presently, after failure of local treatment consisting of surgery and/or radiation therapy, androgen deprivation is the therapy of choice. Unfortunately, resistance to current hormonal therapies eventually occurs. Standard follow-on first line chemotherapy for AIPC patients is docetaxel plus prednisone, resulting in a median overall survival (OS) of 18 months.

Given the mostly palliative nature of this treatment and its side-effects, over-treatment should be avoided, which underscores the need for markers enabling the clinician to identify patients likely to respond to a particular therapy for an overall improved outcome.

This disclosure provides two complementary methods for identifying such patient groups. Such predictive identification should not only make treatment with docetaxel more effective, but it may also increase the efficacy of alternative treatment choices that presently are either not attempted or administered too late to such patients. It has been noted that in the war on cancer, one of the insoluble problems is getting enough patients to test and improve treatments options. Cancer patients tend to change treatment often, which is understandable in view of the serious life-threatening disease. Ethically, providing the best possible treatment from the perspective of survival and quality of life is imperative as is the admonition to do no harm. However, the lack of patients results in potentially promising treatments taking a very long time to be validated. Even, the now relegated second line, treatment with mitxantrone may be suitable as a first line treatment in a suitably defined set of patients, who may then avoid some of the side-effects of docetaxel. Other treatments in the pipeline, such as treatment with monoclonal antibodies to CTLA-4 antigen to boost immune responses promise overcoming the cancer, but only in a fraction of the patients, and thus will also need better patient stratification to best deliver effective patient care.

This disclosure provides a method for predicting from early responses (changes in protein markers and circulating epithelial cell counts) to docetaxel treatment if continued treatment will extend life. Further, the disclosure provides a method for predicting with very high specificity if patients will respond to docetaxel treatment based on the presence of absence of certain mutations due to fusion events. Together, the two methods will assist in stratifying patients with high specificity and reasonable sensitivity into docetaxel promising and alternative treatment promising groups. The two methods together allow stratification before treatment with docetaxel and soon thereafter, and hence largely avoid the side-effects while improving treatment options. Preferably, such stratification will use the high specificity markers disclosed herein to identify likely responders to docetaxel therapy. Then the remaining patients can be further stratified using CTC counts and one or more of changes in CEC and TF as disclosed to identify more of the likely responders to docetaxel treatment early in the treatment. In view of the known side-effects of docetaxel and the grim prognosis associated with AIPC with metastasis, the patients with the assistance of their physicians will be better able to select alternative therapies resulting in a rolling improvement in options for treating AIPC and prostate cancer in general. Similar approaches can be extended to other carcinomas such as skin, breast and colon based carcinomas.

It will be apparent to those skilled in the art that various modifications and variations can be made to the disclosed methods and processes. Thus, it is intended that the present disclosure cover such modifications and variations, provided they come within the scope of the appended claims and their equivalents.

Further, the disclosure of all publications cited above is expressly incorporated herein by reference in their entirety to the same extent as if each were incorporated by reference individually.

1. A method for stratifying patients diagnosed with metastatic prostate cancer for improving treatment, the method comprising:
Screening patients for the presence of at least one high specificity marker; and
Stratifying patients based on the result of said screening step such that at least one group of patients is predicted to be responsive to docetaxel treatment.

2. The method of claim 1 wherein the high specificity marker exhibits a specificity of about 85%, more preferably greater than 90% and most preferably greater than 95% for predicting responsiveness to docetaxel treatment.

3. The method of claim 1 wherein the step of stratifying also identifies a group of patients predicted to be responsive to a treatment other than docetaxel treatment.

4. The method of claim 2 wherein the step of screening detects the presence of a fusion event in the genome of patients.

5. The method of claim 1 wherein the step of stratifying has a sensitivity in detecting response to treatment of at least 30%, more preferably greater than 40% and most preferably of greater than 50%.

6. The method of claim 1 wherein the step of stratifying also identifies a group of patients suitable for consenting to a trial of a new treatment for metastatic prostate cancer.

7. The method of claim 3 wherein the step of screening is completed before administration of docetaxel treatment begins.

8. The method of claim 7 wherein docetaxel treatment is initiated in response to a result of the step of screening.

9. A method for stratifying patients diagnosed with metastatic prostate cancer for improving treatment, the method comprising:
Screening patients for the presence of at least one marker or change in the at least one marker; and
Stratifying patients based on the result of said screening step such that at least one group of patients is predicted to be responsive to docetaxel treatment.

10. The method of claim 9 wherein the step of stratifying also identifies a group of patients predicted to be responsive to a treatment other than docetaxel treatment.

11. The method of claim 9 wherein the step of screening detects the presence of a specified fusion event in the patients.

12. The method of claim 9 wherein the step of screening detects at least one marker in addition to the specified fusion event.

13. The method of claim 9 wherein the step of stratifying exhibits a specificity of about 85%, more preferably greater than 90% and most preferably greater than 95% in identifying patients likely to respond to docetaxel.

14. The method of claims 11 wherein the step of stratifying has a sensitivity of at least 30%, more preferably greater than 40% and most preferably of greater than 50% in detecting patients likely to respond to docetaxel.

15. The method of claim 9 wherein the step of stratifying also identifies a group of patients predicted to exhibit a better response to treatment with mitoxantrone than unstratified patients.

16. The method of claim 9 wherein the step of stratifying also identifies a group of patients suitable for consenting to a trial of a new treatment for metastatic prostate cancer.

17. The method of claim 9 wherein the step of screening is completed at least a week after docetaxel treatment begins, more preferably four weeks after docetaxel treatment and most preferably at about five weeks after docetaxel treatment.

18. The method of claim 9 wherein the step of screening is completed before docetaxel treatment begins.

19. The method of claim 9 wherein docetaxel treatment is stopped in response to a result of the step of screening.

20. The method of claims 12 wherein the step of stratifying has a sensitivity of at least 30%, more preferably greater than 40% and most preferably of greater than 50% in detecting patients likely to respond to docetaxel.
